(19) United States
(12) Patent Application Publication
(10) Pub. No.: US 2012/0021130 A1
(43) Pub. Date: Jan. 26, 2012

(54) METHOD FOR INHIBITING DECOMPOSITION OF METAL SULFIDE-CONTAINING MATERIAL

(75) Inventors: Daniel R. Strongin, Wynnewood, PA (US); Martin Schoonen, Miller Place, NY (US); JUn Hao, Guangzhou (CN)

(73) Assignees: THE RESEARCH FOUNDATION OF THE STATE UNIVERSITY OF NEW YORK, STONY BROOK, Stony Brook, NY (US); TEMPLE UNIVERSITY - OF THE COMMONWEALTH SYSTEM OF HIGHER EDUCATION, Philadelphia, PA (US)

(21) Appl. No.: 13/255,227

(22) PCT Filed: Mar. 4, 2010
(86) PCT No.: PCT/US10/26192

§ 371 Date: Sep. 7, 2011

Related U.S. Application Data
(60) Provisional application No. 61/209,761, filed on Mar. 10, 2009.

(51) Int. Cl. B05D 3/10; B05D 7/00; B05D 5/00; C09D 191/00

(52) U.S. Cl. 427/337; 106/243

(57) ABSTRACT

This invention provides methods of producing a crosslinked lipid coating on a metal sulfide-containing material using a chemical initiator. The crosslinked lipid coating attached to the surface of the material prevents dissolution or oxidation of the material. The methods may be useful to prevent oxidation and leaking of sulfide-containing material in the environment and may be used in the control of environmental pollution.

### CROSS REFERENCE TO RELATED APPLICATIONS

This application claims the benefit of U.S. Application Ser. No. 61/209,761 filed Mar. 10, 2009, the entire disclosure of which is incorporated herein by reference.

### REFERENCE TO GOVERNMENT GRANT

The invention described herein was supported in part by the Government grant numbers DEFG0296ER14633 and DEFG029ER14644, awarded by the Department of Energy—Basic Energy Sciences. The Federal Government may have certain rights in the invention.

### FIELD OF INVENTION

The invention relates to a method of preventing decomposition of a metal sulfide-containing material by coating the material with a composition comprising a two-tail lipid that presents one or more crosslinkable groups in at least one of its hydrophobic tails. Treatment of the lipid-coated metal sulfide-containing material with a chemical initiator causes crosslinking of the hydrophobic tails, protecting the material from chemical and bacterial degradation. The invention also relates to a method of preventing decomposition of a metal sulfide-containing material by treating a composition comprising a two-tail lipid that presents one or more crosslinkable groups in at least one of its hydrophobic tails with a chemical initiator, causing crosslinking of the hydrophobic tails. Treatment of the metal sulfide-containing material with the composition comprising the crosslinked two-tail lipid protects the material from chemical and bacterial degradation. The invention further relates to the suppression of acid mine drainage and acid rock drainage in mining environments, using such a method. The invention also relates to the prevention of decomposition of metal sulfides present in coal and coal mining waste, using such a method.

### BACKGROUND OF INVENTION

Oxidation of metal sulfides during mining and milling operations creates a major environmental challenge, especially when it comes to formation of highly corrosive acidic residue. Acid mine drainage (AMD) and acid rock drainage (ARD) refer to the outflow of acidic water from active or abandoned metal mines or coal mines. AMD and ARD both originate from metal sulfide oxidation, and the terms are sometimes used interchangeably. AMD/ARD may also be observed in areas where construction has exposed sulfide-bearing rock, such as in road cuts and in construction areas. Acid rock drainage occurs naturally within some environments as part of the rock weathering process but is exacerbated by large-scale earth disturbances characteristic of mining and other large construction activities, where rocks containing an abundance of sulfide minerals are involved.

AMD is problematic not only because of its highly acidic character but also due to its high content of toxic metals. AMD is often associated with mining of coal or mining of metal sulfide-containing rocks, which are mined for their content of precious metals (such as platinum, gold, and silver) and base metals (such as zinc, lead, and copper). AMD/ARD is also observed around coal deposits at or near power plants. AMD affects active and inactive mines, and may reach nearby waterways and human dwellings, causing considerable environmental and financial impact.

AMD generation is generally initiated by exposure of the metal sulfide mineral, such as pyrite (FeS₂), to an oxidizing environment, such as the atmosphere. This causes oxidation of the mineral and formation of acids (such as sulfuric and sulfurous acid), along with release of heavy metals. Oxidation of FeS₂ by oxygen is accelerated when dissolved ferric iron [Fe(III)] is present in the system. Colonies of bacteria and archaea greatly accelerate the decomposition of metal sulfide minerals, although decomposition may also occur in an abiotic environment. The microbes most commonly involved with AMD are called extremophiles, for their ability to survive in harsh conditions, and occur naturally in the rock. Acidophiles, a class of extremophiles that excels in acidic environments, are prevalent in mines. One acidophile in particular, Acidithiobacillus ferrooxidans, is a key contributor to pyrite oxidation.

Oxidation may take place with pyrite that is immobilized or mixed with coal, leading to formation of AMD in coal mines and coal repositories (such as those used to store coal at or near power plants). Due to the highly toxic contents of AMD, the runoff from mines must be tightly regulated to minimize environmental contamination. This is an especially difficult problem taking into account how prevalent the use of coal and sulfur-containing minerals is in the modern economy.

Much effort has been dedicated to the prevention or remediation of AMD and ARD. Methods including neutralization by carbonate, neutralization by ion exchange, introduction of wetlands, aeration, and precipitation of metal sulfides have been used, with limited or only partial success. A major issue is that AMD and ARD generally involve a large geographical area, which may be mostly underground and difficult to access, creating technical and financial obstacles. There is thus still great interest in identifying a reliable, long term, and financially manageable economic solution to reduce or prevent oxidation of metal sulfides, such as pyrite, that result in AMD and/or ARD.

One approach taken to prevent or control oxidation of sulfide-containing minerals, and therefore limit AMD and/or ARD, was to encapsulate the minerals with a surface precipitate, such as iron phosphate or silica precipitates, and form a physical barrier separating oxidants from its surface (Evangelou, V. P., 1995, “Potential microencapsulation of pyrite by artificial inducement of ferric phosphate coatings”, J. Environ. Qual. 24, pp. 535-542; Zhang et al., 1998, “Formation of ferric hydroxide-silica coatings on pyrite and its oxidation behavior”, Soil Science 163 (1), pp. 53-62). Removal of dissolved ferric iron from the medium by complexation was shown to minimize the rate of pyrite oxidation (Singer et al., 1970, “Acidic mine drainage: The rate-determining step”, Science 167, pp. 1121-1123; Lalvani et al., 1996, “Coal pyrite passivation due to humic acids and lignin treatment”, Fuel Sci. & Technol. Intern. 14(9), pp. 1291-1313; Peiffer et al, 1999, “The oxidation of pyrite at pH 7 in the presence of reducing and non-reducing Fe(III)-chelators”, Geochim. & Cosmochim. Acta 63, pp. 3171-3182; Backes et al., 1987, “Studies on the oxidation of pyrite in colliery spoil II Inhibition of the oxidation by amendment treatments”, Reclyc. & Reveg. Res. 6, pp. 1-11).

These approaches have not appropriately solved the problem. AMDs have characteristically low pH values (as low as pH values below zero) due to the high concentration of acids. At such low pH values, the encapsulation or complexation approaches generally do not work well, because the protecting phase is solubilized and not stable for long times. Furthermore, some of these approaches cited have their own environmental burdens and may require multiple costly treatments.

Recently a novel method for inhibiting the oxidation of a metal sulfide-containing material, such as ore mine waste rock or metal sulfide tailings, was disclosed (U.S. Pat. No. 7,153,541, incorporated herein by reference in its entirety). The method comprised coating the metal sulfide-containing material with an oxidation-inhibiting two-tail lipid coating. This coating inhibited oxidation of the material in acid mine drainage conditions, and was stable to low pH media, significantly reducing the rate and degree of pyrite oxidation by reducing the accessibility of the pyrite surface to oxidants or microorganisms. Nevertheless, this method still allowed a low but measurable rate of pyrite oxidation.

A significant improvement of this coating method was introduced by Zhang and co-workers (Zhang et al., 2004, “Pyrite oxidation inhibition by a cross-linked lipid coating”, Geochem. Trans. 4 (2), 8-11). Zhang et al. coated the metal sulfide-containing material with a phospholipid displaying diacetylenyl groups in its hydrocarbon tails. Exposure of the construct to ultraviolet (UV) light caused crosslinking of the hydrocarbon tails. Crosslinking of the coating led to further reduction in pyrite oxidation inhibition relative to the unpolymerized lipid, presumably by creating a more impermeable barrier between the pyrite surface and the environment.

This improvement by Zhang et al. still has practical limitations. Field application of the method of Zhang et al. would require the UV irradiation of large volumes of lipid suspensions. This process would necessitate the use of a high intensity, expensive and harmful light source. Furthermore, irradiation would probably only be effective on suspension fronts and rock surface areas. The method could not be applied to underground areas or deep mines, and areas away from the immediate surface would probably not receive sufficient irradiation, not benefitting from the protective treatment.

There is thus great need to identify a method that allows for efficient inhibition of oxidation of metal sulfide-containing materials by forming a highly impermeable barrier on the surface of the material, without depending on the use of UV light to form the barrier. The present invention addresses this need.

### SUMMARY OF INVENTION

As described herein, the inventors have surprisingly discovered a method for protecting a metal sulfide-containing material from chemical or biological degradation. In a preferred embodiment, the method comprises treating the metal sulfide-containing material with a composition comprising a two-tail lipid, wherein at least one of the tails of the two-tail lipid contains one or more crosslinkable groups, as to generate a non-crosslinked lipid-coated metal sulfide-containing material, and then exposing the non-crosslinked lipid-coated metal sulfide-containing material to a chemical initiator, whereupon the tails of the lipid undergo crosslinking and render the lipid coating resistant to chemical and biological degradation. In another embodiment, the method of the invention comprises treating a composition comprising a two-tail lipid, wherein at least one of the tails of the two-tail lipid contains one or more crosslinkable groups, with a composition comprising a chemical initiator, whereupon the tails of the lipid undergo crosslinking, and then exposing the metal sulfide-containing material to a composition comprising the crosslinked lipid, whereupon a crosslinked lipid-coated metal sulfide-containing material is generated and the material is rendered resistant to chemical and biological degradation. Such method finds use in the suppression of acid mine drainage and acid rock drainage in mining environments, as well as in prevention of decomposition of metal sulfides present in coal and coal ores.

The invention provides a method for inhibiting the oxidation or degradation of a metal sulfide-containing material. In one embodiment of the invention, the method comprises the steps of contacting the metal sulfide-containing material with an effective amount of a first liquid dispersion comprising a lipid composition comprising a two-tail lipid, wherein the two-tail lipid comprises a hydrophilic head group attached to two hydrophobic tails, wherein at least one of the two hydrophobic tails contains one or more crosslinkable groups, thereby providing a non-crosslinked lipid-coated metal sulfide-containing material; and then contacting the non-crosslinked lipid-coated metal sulfide-containing material with an effective amount of a second liquid dispersion comprising a chemical initiator, as to form a cross-linked lipid-coated material. In another embodiment of the invention, the method comprises the steps of contacting an effective amount of a first liquid dispersion comprising a lipid composition comprising a two-tail lipid, wherein the two-tail lipid comprises a hydrophilic head group attached to two hydrophobic tails, wherein at least one of the two hydrophobic tails contains one or more crosslinkable groups, with an effective amount of a second liquid dispersion comprising a chemical initiator, thereby providing a third liquid dispersion comprising a cross-linked lipid; and then contacting the metal sulfide-containing material with the third liquid dispersion, as to form a cross-linked lipid-coated material.

According to one embodiment of the invention, the metal sulfide-containing material is selected from the group consisting of ore mine waste rock and metal sulfide tailings. In another embodiment, the metal sulfide-containing material comprises one or more metal sulfides selected from the group consisting of pyrite, marcasite, arsenopyrite, argentite, chalcopyrite, cinnabar, galena, molybdenite, pentlandite, realgar, sphalerite, stibnite, and combinations thereof.

According to one embodiment of the invention, the hydrophilic head group is selected from the group consisting of phosphate, phosphoryl, sulfate, amino, amine, carboxylate, hydroxyl, thiol, carbonyl, and combinations thereof.

According to one embodiment of the invention, the one or more crosslinkable groups are selected from the group consisting of alkenyl and alkynyl groups. In another embodiment, at least one of the one or more crosslinkable groups is diacetylenyl.

According to one embodiment of the invention, the chemical initiator is selected from the group consisting of hydrogen peroxide equivalents, azocompounds, and redox systems. In another embodiment, the hydrogen peroxide equivalents comprise a mixture of sodium bisulfite and sodium peroxodisulfate.

According to one embodiment of the invention, the two hydrophobic groups of the two-tail lipid are attached to the hydrophilic head group by an ether or ester bond. In another embodiment, at least one of the two hydrophobic groups comprises a fatty acid moiety. In yet another embodiment, the fatty acid moiety is selected from the group consisting of 10,12-tricosadiynoyl, myristoleoyl, myristelaidoyl, palmitoleoyl, palmitelaidoyl, petroselinoyl, oleoyl, elaidoyl, linoleoyl, linolenoyl, eicosenoyl, arachidonoyl, erucoyl, 4,7,10,13,16,19-(all-cis)-docosahexaenoic, and nervonoyl. In a preferred embodiment, the fatty acid moiety is 10,12-tricosadiynoyl. In yet another preferred embodiment, the two-tail lipid is 1,2-bis(10,12-tricosadiynoyl)-sn-glycero-3-phosphocholine.

According to one embodiment of the invention, the lipid composition further comprises a lipid selected from the group consisting of phosphatidylcholine, phosphatidylethanolamine, phosphatidic acid, phosphatidylinositol, sphingomyelin, diacyl glycerol, phosphatidyl ethanolamine, diacylaminopropanediols, disteroylaminopropanediol, phosphatidylglycerol, distearyl phosphatidylcholine, egg sphingomyelin, 1,2-dipalmitoyl-sn-glycero-3-[phospho-L-serine], 1,2-dimyristoyl-sn-glycero-3-[phospho-rac-(1-glycerol)], 1,2-bis(10,12-tricosadiynoyl)-sn-glycero-3-phosphocholine, 1,2-di-O-octadecyl-sn-glycero-3-phosphocholine and combinations thereof.

According to another embodiment of the invention, the lipid composition in the first liquid dispersion ranges in concentration from about 10 micromolar to about 30 millimolar. In another embodiment, the chemical initiator in the second liquid dispersion ranges in concentration from about 3 micromolar to about 30 millimolar.

The invention also provides a method for treating acid mine drainage. In one embodiment of the invention, the method comprises the steps of contacting a source of the acid mine drainage with an effective amount of a first liquid dispersion comprising a lipid composition comprising a two-tail lipid, wherein the two-tail lipid comprises a hydrophilic head group attached to two hydrophobic tails, wherein at least one of the two hydrophobic tails contains one or more crosslinkable groups, thereby providing a non-crosslinked lipid-coated metal sulfide-containing material; and contacting the non-crosslinked lipid-coated metal sulfide-containing material with an effective amount of a second liquid dispersion comprising a chemical initiator, thereby providing a crosslinked lipid-coated metal sulfide-containing material. In another embodiment of the invention, the method comprises the steps of contacting an effective amount of a first liquid dispersion comprising a lipid composition comprising a two-tail lipid, wherein the two-tail lipid comprises a hydrophilic head group attached to two hydrophobic tails, wherein at least one of the two hydrophobic tails contains one or more crosslinkable groups, with an effective amount of a second liquid dispersion comprising a chemical initiator, thereby providing a third liquid dispersion comprising a crosslinked two-tail lipid; and contacting a source of the acid mine drainage with the third liquid dispersion.

In one embodiment of the invention, the source of the acid mine drainage comprises a metal sulfide-containing material. In another embodiment, the metal sulfide-containing material is selected from the group consisting of ore mine waste rock and metal sulfide tailings. In yet another embodiment, the metal sulfide-containing material comprises one or more metal sulfides selected from the group consisting of pyrite, marcasite, arsenopyrite, argentite, chalcopyrite, cinnabar, galena, molybdenite, pentlandite, realgar, sphalerite, stibnite, and combinations thereof.

The invention also provides a composition comprising a metal sulfide-containing material, wherein a crosslinked lipid coating spans at least a portion of the metal sulfide-containing material. In one embodiment of the invention, the composition of the invention is prepared by a method comprising the steps of contacting the metal sulfide-containing material with an effective amount of a first liquid dispersion of a lipid composition comprising a two-tail lipid, wherein the two-tail lipid comprises a hydrophilic head group attached to two hydrophobic tails, wherein at least one of the two hydrophobic tails contains one or more crosslinkable groups, thereby providing a non-crosslinked lipid-coated metal sulfide-containing material; and contacting the non-crosslinked lipid-coated metal sulfide-containing material with an effective amount of a second liquid dispersion comprising a chemical initiator, thereby providing a crosslinked lipid-coated metal sulfide-containing material. In another embodiment of the invention, the composition of the invention is prepared by a method comprising the steps of contacting an effective amount of a first liquid dispersion of a lipid composition comprising a two-tail lipid, wherein the two-tail lipid comprises a hydrophilic head group attached to two hydrophobic tails, with an effective amount of a second liquid dispersion comprising a chemical initiator, thereby providing a third liquid dispersion comprising a crosslinked two-tail lipid; and contacting the metal sulfide-containing material with the third liquid dispersion, thereby providing a crosslinked lipid-coated metal sulfide-containing material.

In another embodiment, the metal sulfide-containing material is selected from the group consisting of ore mine waste rock and metal sulfide tailings. In yet another embodiment, the metal sulfide-containing material comprises one or more metal sulfides selected from the group consisting of pyrite, marcasite, arsenopyrite, argentite, chalcopyrite, cinnabar, galena, molybdenite, pentlandite, realgar, sphalerite, stibnite, and combinations thereof.

As envisioned in the present invention with respect to the disclosed compositions of matter and methods, in one aspect the embodiments of the invention comprise the components and/or steps disclosed therein. In another aspect, the embodiments of the invention consist essentially of the components and/or steps disclosed therein. In yet another aspect, the embodiments of the invention consist of the components and/or steps disclosed therein.

### DESCRIPTION OF FIGURES

FIG. 1 shows a diagram representation of the assembly of two-tail lipids in a bilayer structure on the surface of a metal sulfide-containing material. Label (A) indicates the metal sulfide-containing material, label (B) indicates the hydrophilic head of the lipid, and label (C) indicates the hydrophobic tails of the lipid.

FIG. 2 shows the effects of chloroform on the stability of various lipid liposome preparations. Panel A shows non-crosslinked 1,2-bis(10,12-tricosadiynoyl)-sn-glycero-3-phosphocholine (23:2 PC diyne) lipid. Panel B shows 23:2 PC diyne lipid crosslinked by chemical initiators. Panel C shows egg PC treated with chemical initiators. Panel D shows 23:2 PC diyne lipid crosslinked by UV light.

FIG. 3 shows the infrared spectroscopy data of 23:2 PC diyne lipid not-crosslinked (top trace) and 23:2 PC diyne lipid crosslinked by chemical initiators (bottom trace).

FIG. 4 shows the concentration of aqueous iron released from pyrite as a function of time, under the following experimental conditions: (a) pyrite by itself (symbol ♦); (b) pyrite exposed to the organism A. ferrooxidans (symbol ▪); (c) pyrite exposed to the organism A. acidophilum (symbol ); and (d) pyrite exposed to the organisms A. ferrooxidans and A. acidophilum (symbol ▾). All reactions were run at initial pH of 2, and the iron concentrations in solution were calculated using the ferrozine method.

FIG. 5 shows the concentration of aqueous iron released from pyrite as a function of time, under the following experimental conditions: (a) pyrite by itself (symbol □); (b) pyrite exposed to the organisms A. ferrooxidans and A. acidophilum (symbol ∘); (c) pyrite pretreated with non-crosslinked lipid (non-crosslinked lipid-coated pyrite) (symbol ▪); and (d) non-crosslinked lipid-coated pyrite further exposed to the organisms A. ferrooxidans and A. acidophilum (symbol ). All reactions were run at initial pH of 2, and the iron concentrations in solution were calculated using the ferrozine method.

FIG. 6 shows ex situ atomic force microscopy (AFM) images of pyrite. Panel (a) corresponds to pyrite exposed to 23:2 PC diyne lipid for 24 hours. Panel (b) corresponds to pyrite exposed to 23:2 PC diyne lipid for 24 hours, and then treated with a chemical initiator for 1 day. Panel (c) corresponds to pyrite exposed to 23:2 PC diyne lipid for 24 hours, and then treated with a chemical initiator for 2 days.

FIGS. 7a-c shows in situ AFM images of pyrite. FIG. 7a corresponds to pyrite exposed to 23:2 PC diyne lipid for 48 hours. FIG. 7b corresponds to pyrite exposed to 23:2 PC diyne lipid for 48 hours, and then exposed to a chemical initiator for 20 minutes. FIG. 7c corresponds to pyrite exposed to 23:2 PC diyne lipid for 48 hours, and then exposed to a chemical initiator for 40 minutes. For these figures, images on the left are amplitude images, and images on the right are phase images.

FIG. 8 shows a schematic representation for proposed crosslinking mechanism for the 23:2 PC diyne lipid. Chemical initiators cause crosslinking of lipid molecules via the reorganization of the diacetylenic groups and formation of C═C groups. Multilayers may be formed by a crosslinking mechanism, provided there is enough amount of lipid available.

FIG. 9 shows the concentration of iron ion released from pyrite, as a function of time, under the following experimental conditions: (a) pyrite by itself (symbol ▾); (b) non-crosslinked lipid-coated pyrite (symbol ∘); (c) non-crosslinked lipid-coated pyrite exposed to the organisms A. ferrooxidans and A. acidophilum (symbol ∇); and (d) crosslinked lipid-coated pyrite exposed to the organisms A. ferrooxidans and A. acidophilum (symbol ). All reactions were run at initial pH of 2, and the iron concentrations in solution were calculated using the ferrozine method.

### Definitions

The definitions used in this application are for illustrative purposes and do not limit the scope used in the practice of the invention.

Unless defined otherwise, all technical and scientific terms used herein generally have the same meaning as commonly understood by one of ordinary skill in the art to which this invention belongs. Generally, the nomenclature used herein and the laboratory procedures in chemistry, analytical chemistry, lipid chemistry, geochemistry and mineralogy are those well known and commonly employed in the art.

The articles “a” and “an” are used herein to refer to one or to more than one (i.e. to at least one) of the grammatical object of the article. By way of example, “an element” means one element or more than one element.

The term “about” will be understood by persons of ordinary skill in the art and will vary to some extent on the context in which it is used.

As used herein, an “unsaturated” compound or group refers to one or more double or triple bonds within the compound or group.

As used herein, the term “lipid” refers to a any fat-soluble (lipophilic) molecule, such as fats, oils, waxes, cholesterol, sterols, fat-soluble vitamins (such as vitamins A, D, E and K), monoglycerides, diglycerides, phospholipids, and others. As used herein, a “fatty acid” is a carboxylic acid that has 4 or more carbon atoms and is either saturated or unsaturated.

As used herein, the term “hydrophilic head group” of a lipid refers to a water-soluble (hydrophilic) portion of the lipid capable of interacting with polar substrates, such as water or ionic compounds. Examples of hydrophilic head groups include, but are not limited to, phosphate [—OP(═O)(O⁻)₂ as a terminal group, or —OP(═O)(O⁻)O— as a connecting group], phosphoryl [—OP(O⁻)₂], sulfate [—OS(═O)₂(O⁻)], amino (—NH₂ or —NH₃⁺), amines (primary, secondary, tertiary or quaternary), carboxylate (—C(═O)O⁻), hydroxyl (—OH), thiol (—SH), carbonyl, or acyl functional groups, and the like and combinations thereof.

As used herein, the term “hydrophobic tail” refers to a carbon-containing portion of the lipid molecule. The hydrophobic tail may be aliphatic or aromatic, or a combination thereof. The hydrophobic tail of the lipid may be saturated or unsaturated. A hydrophilic head group may be attached to one or more hydrophobic tails, which may be identical or different from each other. The expression “attached to”, as used herein with reference to the hydrophilic head group having two or more of the same or different hydrophobic tails attached to it, shall be understood to mean that the hydrophobic tails can be directly bonded to the hydrophilic head group or can be indirectly bonded to the hydrophilic head group, whereby, for example, each of the hydrophobic tails is bonded directly to the same linking group or different linking groups such as, for example, an ether or ester group, and the linking group is bonded to the hydrophilic head group. The hydrophobic tail may comprise a “fatty acid moiety”, where a naturally occurring or synthetic fatty acid is incorporated in the hydrophobic tail by means of a chemical linkage, such as, but not limited to, an ester or amide linkage.

As used herein, the term “two-tail lipid” refers to a lipid comprising a hydrophilic head group attached to two of the same or different hydrophobic tails.

As used herein, the term “metal sulfide” refers to compounds containing both metal cations and sulfide or disulfide anions. The metal sulfide may refer to a chemical compound synthesized by standard chemical methods or obtained from commercial sources. The metal sulfide may also be present in naturally occurring or isolated minerals, such as pyrite (iron disulfide, FeS₂), marcasite (white iron pyrite, FeS₂), arsenopyrite (FeAsS), argentite (Ag₂S), chalcopyrite (CuFeS₂), cinnabar (HgS), galena (PbS), molybdenite (MoS₂), pentlandite [(Fe,Ni)₉S₈], realgar (alpha-As₄S₄), sphalerite [(Zn,Fe)S], stibnite (Sb₂S₃). The metal sulfide may be present as an impurity, a high content component or a low content component in a multitude of ores, including coals.

As used herein, the term “crosslink” refers to the establishment of one or more covalent bonds between two or more groups present in a molecule or group of molecules. In the case that the one or more covalent bonds are formed within the same molecule, the crosslink is called intramolecular. In the case that one or more covalent bonds are formed between two molecules or among more than two molecules, the crosslink is called intermolecular.

As used herein, the term “crosslinkable group” refers to a chemical group on the hydrophobic tail of a lipid capable of undergoing or promoting crosslinking with another crosslinkable group on the same hydrophobic tail or another hydrophobic tail. The preferred crosslinkable groups within the teachings of the invention are unsaturated groups, such as alkenyl groups (C═C) and alkynyl (C≡C) groups. The alkenyl groups may be monosubstituted, disubstituted, trisubstituted and tetrasubstituted, and the alkynyl groups may be monosubstituted and disubstituted. The groups may be incorporated at any position of the hydrophobic tail of the lipid. When the lipid contains more than one hydrophobic tail, the crosslinkable group may be incorporated in one or more of the hydrophobic tails. The hydrophobic tail containing one or more crosslinkable groups may be referred to as “crosslinkable-group containing tail”.

As used herein, the terms “diacetylene”, “diacetylenyl”, “diyne” and “diynyl” refer to the moiety —C≡C—C≡C—. This moiety may be incorporated at any position of the hydrophobic tail.

As used herein, the term “chemical initiator” refers to a chemical compound or a mixture of chemical compounds that may be used to promote crosslinking through appropriate activation of a crosslinkable group. In general, a chemical initiator acts as a radical initiator, but the exact chemical role of the chemical initiator depends on the nature of the crosslinkable group under consideration and the initiation conditions, and is not meant to limit the scope of the present invention. In the case that the crosslinkable group comprises an alkenyl or an alkynyl group, the chemical initiator may be selected from the group of compounds consisting of hydrogen peroxide equivalents, azocompounds, and redox systems.

Examples of hydrogen peroxide equivalents include, but are not limited to, t-butyl hydroperoxide, cumene hydroperoxide, t-butyl peroxyacetate, t-butyl peroxybenzoate, t-butyl peroxyoctoate, t-butyl peroxyneodecanoate, t-butyl peroxyisobutarate, lauroyl peroxide, t-amyl peroxypivalate, t-butyl peroxypivalate, dicumyl peroxide, benzoyl peroxide, potassium persulfate, sodium persulfate (also known as sodium peroxodisulfate or sodium peroxydisulfate), and ammonium persulfate, and combinations of any of the previously cited compounds with an alkali metal disulfite, such as sodium metabisulfite or sodium bisulfite.

Examples of azocompounds include, but are not limited to, 2,2′-azobis(isobutyronitrile), 2,2′-azobis(2-butanenitrile), 4,4′-azobis(4-pentanoic acid), 1,1′-azobis(cyclohexanecarbonitrile), 2-(t-butylazo)-2-cyanopropane, 2,2′-azobis[2-methyl-N-(1,1)-bis(hydroxymethyl)-2-hydroxyethyl]propionamide, 2,2′-azobis[2-methyl-N-hydroxyethyl]propionamide, 2,2′-azobis(N,N′-dimethyleneisobutyramidine) dichloride, 2,2′-azobis(2-amidinopropane)dichloride, 2,2′-azobis(N,N′-dimethyleneisobutyramide), 2,2′-azobis (2-methyl-N-[1,1-bis(hydroxymethyl)-2-hydroxyethyl]propionamide), 2,2′-azobis(2-methyl-N-[1,1-bis(hydroxymethyl)ethyl]propionamide), 2,2′-azobis[2-methyl-N-(2-hydroxyethyl)propionamide], and 2,2′-azobis(isobutyramide)dehydrate.

Examples of redox systems include, but are not limited to, the following combinations: (a) mixtures of hydrogen peroxide, alkyl peroxide, peresters, percarbonates and the like, and of any one of iron salts, titanous salts, zinc formaldehyde-sulfoxylate or sodium formaldehyde-sulfoxylate, and reducing sugars; (b) alkali metal or ammonium persulfates, perborate or perchlorate, in combination with an alkali metal disulfite, such as sodium metabisulfite, and reducing sugars; and (c) alkali metal persulfate, in combination with an arylphosphinic acid, such as benzenephosphonic acid and other similar acids, and reducing sugars.

### DETAILED DESCRIPTION OF INVENTION

The present invention is based on the unexpected discovery that a chemical initiator may be used in the creation of a crosslinked lipid coating on metal sulfides and metal sulfide-containing materials, protecting them from degradation or decomposition by chemicals or microorganisms. The crosslinked lipid coating of the invention is envisioned to partially or completely coat the surface of the metal sulfide, isolating the metal sulfide or a portion thereof from the immediate environment and protecting the metal sulfide or a portion thereof from chemical reagents or microorganisms. The fact that the crosslinking of the lipid coating is activated by a chemical initiator allows for the practice of the invention in the laboratory, in open fields, in chemical plants, in energy generating plants, and in underground areas. This invention may be used to suppress acid mine drainage and acid rock drainage, due to the oxidation of metal sulfides in coal mining areas and areas where metal sulfides are exposed to oxidizing conditions. This invention may also be used to prevent decomposition of metal sulfides present in coal ore that is stored at power generating plants. The invention may also be used to prevent decomposition of metal sulfides or metal sulfide-containing materials within road cuts.

According to the experiments discussed herein, crosslinking of the hydrophobic tail of a lipid liposome rendered the liposome more resilience to dissociation and solubilization by an organic solvent (chloroform). Chemical crosslinking of the hydrophobic tail was found to be more efficient than UV-mediated crosslinking under the reaction conditions described herein. When present on the surface of a metal sulfide, the crosslinked lipid coating offered an enhanced protection against dissolution, even in the presence of microorganisms known to accelerate dissolution of non-crosslinked lipid-coated metal sulfides.

The present invention relates to treatment of a metal sulfide. As used in this disclosure, the metal sulfide corresponds to one or more compounds that contain a sulfide and/or disulfide anion, along with at least one metal ion. The invention contemplates using metal sulfides of various purity levels, from materials comprising one or more mostly pure metal sulfides to materials where the metal sulfide is present as a minor impurity. The metal sulfide considered in the invention may be synthesized via a chemical reaction or obtained from a commercial source. The metal sulfide may also be present in naturally occurring or isolated minerals. When present as part of mineral matter, the metal sulfide may constitute the majority of the mineral matter, or may be present as a desirable or undesirable impurity or minor component. Non-limiting examples of metal sulfides are pyrite (iron disulfide, FeS₂), marcasite (white iron pyrite (FeS₂), arsenopyrite (FeAsS), argentite (Ag₂S), chalcopyrite (CuFeS₂), cinnabar (HgS), galena (PbS), molybdenite (MoS₂), pentlandite (Fe,Ni)₉S₈, realgar (alpha-As₄S₄), sphalerite ((Zn,Fe)S), and stibnite (Sb₂S₃). Such metal sulfides may be found in metal sulfide-containing material as coal, earth strata, rocks, mine tailings, gob piles, waste products from ore purification processes, and the like.

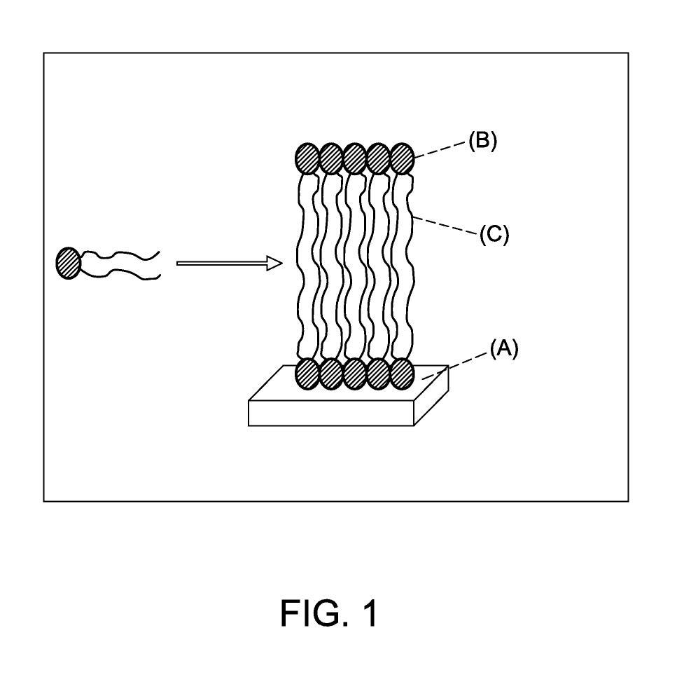

The invention also relates to a lipid composition. As used herein, the term “two-tail lipid” refers to a lipid comprising a hydrophilic head group attached to two of the same or different hydrophobic tails. As envisioned by the present invention, the lipid composition comprises one or more two-tail lipids, wherein at least one of the hydrophobic tails of the one or more two-tail lipids contains a crosslinkable group. While not wishing to be bound by theory, it is believed that two-tail lipids will form structures in aqueous solution that allow for the interaction of their polar heads with the solution and the isolation of the hydrophobic tails from the solution. Due to geometric constraints inherent in their structures, two-tail lipids will tend to form a bilayer structure, since this formation will prevent the formation of water pockets between their hydrophobic tails. In this manner, when the two-tail lipid is contacted with the metal sulfide-containing material, the hydrophilic groups in the two-tail lipid may interact with the surface of the metal sulfide-containing material, creating an organized structure that acts as an oxidation-inhibiting coating upon exposure to water and oxygen, substantially preventing any initial or further oxidation of the metal sulfide-containing material. This is schematically represented in FIG. 1, where the two-tail lipid is contacted with metal sulfide containing material (indicated as A), and the hydrophilic head group (indicated as B) interacts with the surface of metal sulfide-containing material, forming a first layer. Since the two hydrophobic tails (indicated as C) repel water, they could be isolated from water by attachment of a second layer of two-tail lipid, where the hydrophobic tails of the first layer interact with the hydrophobic tails of the second layer and the hydrophilic head groups of the second layer interact with water. It is suspected therefore that the two-tail lipids adsorbed on a surface and exposed to water may adopt a bilayer structure. As envisioned in the present invention, the bilayer structure does not have to necessarily span the whole surface of the metal sulfide-containing material to afford appropriate protection of the material towards decomposition or oxidation. Similarly, the surface of the metal sulfide may be coated by multiple layers of the lipid-based coating as well.

Lipids that may be part of the lipid composition comprise a variety of synthetic and naturally occurring lipids. Representative of these types of lipids are illustrated in Voet & Voet, 1995, Biochemistry, Chapter 11—Lipids and Membranes, pp. 277-290 (John Wiley & Sons, NYC, N.Y.), the contents of which are incorporated by reference herein. Such lipids can either form bilayers spontaneously in water, as exemplified by the phospholipids, or are stably incorporated into lipid bilayers, with its hydrophobic moiety in contact with the interior hydrophobic region of the bilayer membrane, and its head group moiety oriented toward the exterior.

Lipids that may be part of the lipid composition include the phospholipids, e.g., phosphatidylcholine, phosphatidylethanolamine, phosphatidic acid, phosphatidylinositol, and sphingomyelin, where the two hydrocarbon chains are typically between about 10-24 carbon atoms in length, and have varying degrees of saturation. The above-described lipids and phospholipids which chains have varying degrees of saturation can be obtained commercially or prepared according to published methods. Other suitable lipids include sphingolipids and glycolipids. Preferred lipids for use herein include, but are not limited to, diacyl glycerol, phosphatidyl ethanolamine (PE), diacylaminopropanediols, such as disteroylaminopropanediol (DS), phosphatidylglycerol (PG) and distearyl phosphatidylcholine (DSPC), egg sphingomyelin, 1,2-dipalmitoyl-sn-glycero-3-[phospho-L-serine] (16:0 PS), 1,2-dimyristoyl-sn-glycero-3-[phospho-rac-(1-glycerol)] (16:0 DGS), 1,2-bis(10,12-ticosadiynoyl)-sn-glycero-3-phosphocholine (23:2 diyne PC), 1,2-di-O-octadecyl-sn-glycero-3-phosphocholine (18:0 diether PC) and the like.

The hydrophobic tails on the two-tail lipids may be the same or different hydrocarbon chains. Suitable hydrocarbon chains include those that are saturated or those having varying degrees of unsaturation and include, for example, an alkyl, an alicyclic or an alkylalicyclic group having from about 10 to about 24 carbon atoms or an alkylaryl where the alkyl group is from about 10 to about 24 carbon atoms, including, by way of illustration, unsubstituted straight or branched aliphatic, cycloaliphatic and aromatic groups and cycloaliphatic and aromatic groups substituted with one or more straight or branched aliphatic, cycloaliphatic and/or aromatic groups.

As envisioned by the present invention, at least one of the hydrophobic tails of the lipid should contain one or more crosslinkable groups. The presence of the crosslinkable group in at least one of the hydrophobic groups allows for the eventual intermolecular crosslinking of the hydrophobic groups and rigidification of the overall structure. The crosslinkable group may be part of a fatty acid moiety.

The preferred fatty acid moieties of the invention are, but not limited to, 10,12-tricosadiynoyl (23:2 diyne), myristoleoyl (9-cis-tetradecenoic), myristelaidoyl (9-trans-tetradecenoic), palmitoleoyl (9-cis-hexadecenoic), palmitelaidoyl (9-trans-hexadecenoic), petroselinoyl (6-cis-octadecenoic), oleoyl (9-cis-octadecenoic), elaidoyl (9-trans-octadecenoic), linoleoyl (9-cis-12-cis-octadecadienoic), linolenoyl (9-cis-12-cis-15-cis-octadecatrienoic), eicosenoyl (11-cis-eicosenoic), arachidonoyl (5,8,11,14(all-cis-eicosatetraenoic), erucoyl (13-cis-docosenoic), 4,7,10,13,16,19-(all-cis)-docosahexaenoic, and nervonoyl (15-cis-tetracosenoic).

Generally, the hydrophilic head groups of the two-tail lipid include, but are not limited to, phosphate, phosphoryl, sulfate, amino, amines, carboxylate, hydroxyl, thiol, carbonyl or acyl functional groups, and the like and combinations thereof.

The composition of the invention, if available as a solid, may be reduced to powder form by any means known to those skilled in the art. The lipid used herein, whether liquid or solid, is preferably suspended, dispersed, or dissolved into an aqueous solution (such as water, an aqueous solution of dilute acid, an aqueous solution of dilute base or an aqueous solution of salt, or a combination thereof) to form the lipid composition employed herein as the oxidation-inhibiting lipid coating. Some or all of the lipids may be suspended, dispersed, or dissolved into an aqueous solution containing a percentage of organic solvent, as long as the content of organic solvent does not prevent attachment of the lipid to the metal sulfide. Suspension, dispersion or dissolution of the lipid in a liquid may be achieved by mechanical agitation, mechanical stirring or sonication, or any other method that does not cause partial or total degradation of the lipid.

In a preferred embodiment, the lipid composition of the invention may then be brought into contact directly with metal sulfides, with the source of the AMD, i.e., the metal sulfide-containing material, or with the AMD waters. Preferably, the lipid composition of the invention is first dispersed, suspended, or dissolved into water and then contacted with the metal sulfide-containing material and/or added to an area to be treated (e.g., AMD waters). The contact of the lipid composition with the metal sulfide-containing material may be implemented by any known means of applying a solution including, but not limited to, injecting, spraying and pouring. In working with powdered or granular waste as the metal sulfide-containing material, it is preferable to add the lipid composition of the invention to a water-based slurry of the waste. This may improve contact and dispersion of the lipid(s) among the waste. Preferably, an effective amount of the lipid composition of the invention is suspended, dispersed, and/or dissolved in the aqueous or partially aqueous solution, so that a concentration of from about 10 micromolar to about 30 millimolar of the lipid is present in the liquid to be used in the preparation of the oxidation-inhibiting lipid coatings of the present invention.

Generally, an effective amount of the lipid composition of the present invention to be used with the metal sulfide-containing material and/or the AMD waters or other aqueous sources is an amount sufficient to interact with most or all reactive sites of the metal sulfide compounds in the metal sulfide-containing material. As such, the amount of the coating to be applied to the metal sulfide-containing material or the area in need of treatment will vary widely, and may be determined to the person skilled in the art, based on the surface area to be treated, the volume of material to be treated, the pH of the material to be treated, the overall moisture level in the material to be treated and the concentration of the lipid composition of the invention. Regarding the treatment of the metal sulfide-containing material, an amount of the lipid composition of the invention to be used should be sufficient to prevent AMD from occurring. Preferably, at least about 250 ml of the aqueous dispersion of composition of the invention containing about 10 micromolar to about 30 millimolar lipid is added per liter of AMD water to be treated in order to achieve the desired treatment, which is preventing further AMD and inhibiting the oxidation of the metal sulfides. More preferably, a 1:1 ratio of aqueous lipid-containing system to AMD water is used. Depending on the compositions used, this value can significantly vary. Similar amounts can be employed in treating the source of AMD (e.g., mine waste rocks such as pyrite). Accordingly, in preventing AMD from occurring or stopping any existing AMD, the lipid composition of the present invention, preferably in aqueous solution or suspension, is added to the AMD waters, as well as the source of the AMD, such as the metal sulfides in the mined waste rocks. This will effectively inhibit the oxidation of the metal sulfides as well as treat any existing AMD.

The amount of contact time between the lipid composition of the invention and the metal sulfide-containing material to ensure proper coating of the metal sulfide-containing material, as required by the present invention, may vary depending on the environmental factors present at the time of the experiment. The contact time may be less than 5 minutes, between 5 and 15 minutes, between 15 and 30 minutes, between 30 minutes and 1 hour, between 1 hour and 5 hours, between 5 hours and 1 day, between 1 day and 3 days, between 3 days and 7 days, between 7 days and 14 days, between 14 days and 1 month, between 1 month and 3 months, between 3 months and 1 year, or any fraction or multiple thereof. The required amount of time of contact between the lipid composition of the invention and the metal sulfide-containing material may be estimated by those skilled in the art, based on sampling of the metal sulfide-containing material and determination of extent of coating of the metal sulfide-containing material using the methods known in the art and/or disclosed in the present application. Along with the contact between the metal sulfide-containing material and the lipid composition of invention, there may be mixing of the metal sulfide-containing material and the lipid composition of the invention. This mixing may be take place at the same time that the lipid composition of the invention is introduced or may take place afterwards. The mixing may involve a mechanical stirrer or similar mechanical mixing device, use vibration devices, or involve other methods, such as passing forced air or forced liquid through the material under treatment.

After the lipid composition of the invention is contacted with the metal sulfide-containing material to allow the lipid composition to coat the metal sulfide-containing material, the chemical initiator may be introduced. The chemical initiator, whether liquid or solid, is preferably suspended, dispersed, or dissolved into an aqueous solution (such as water, an aqueous solution of dilute acid, an aqueous solution of dilute base or an aqueous solution of salt, or a combination thereof) so that it may be more easily handled during application. The chemical initiator may also be suspended, dispersed, or dissolved into an aqueous solution containing some organic solvent, as long as the content of organic solvent does not prevent reaction of the chemical initiator with the lipid and does not significantly disrupt the structure of the lipid on the surface of the metal sulfide-containing material.

The dispersion, suspension or solution of the chemical initiator may then be brought into contact directly with the non-crosslinked lipid-coated metal sulfide-containing material or any corresponding material. The dispersion, suspension or solution of the chemical initiator may be contacted with the non-crosslinked lipid-coated metal sulfide-containing material, or the area to be treated (such as AMD), by any known means of applying a dispersion, suspension or solution including, but not limited to, injecting, spraying and pouring. In working with powdered or granular waste, it is preferable to add dispersion, suspension or solution of the chemical initiator to a water-based slurry of the waste. This may improve contact and dispersion of the chemical initiator among the waste. Preferably, an effective amount of the chemical initiator is suspended, dispersed, and/or dissolved in the aqueous solution, so that a concentration of from about 3 micromolar to about 30 millimolar of the chemical initiator is present in the aqueous solution to promote crosslinking of the lipid tails.

Generally, an effective amount of the chemical initiator to be added to the non-crosslinked lipid-coated metal sulfide-containing material and/or the waste waters and/or other aqueous sources is an amount sufficient to promote appropriate crosslinking of the hydrophobic tails of the lipid that is coating the metal sulfide-containing material. As such, the amount of the chemical initiator to be applied directly to the lipid-coated metal sulfide-containing material or the area in need of treatment will vary widely, and may be determined to the person skilled in the art, based on the surface area to be treated, the volume of material to be treated, the pH of the material to be treated, the overall moisture in the material to be treated and the concentration of the chemical initiator. A sufficient amount of the chemical initiator should be used to ensure adequate crosslinking in the lipid-coated particles. Preferably, at least about 250 ml of the aqueous suspension of the chemical initiator is added per liter of AMD water to be treated in order to achieve the desired treatment, which is crosslinking the hydrophobic chains. More preferably, a 1:1 ratio of chemical initiator solution to AMD water is used. Depending on the compositions used, this value can significantly vary. Similar amounts can be employed in treating the source of lipid-coated AMD (e.g., mine waste rocks such as pyrite). Accordingly, to effectively prevent AMD, the chemical initiator solution, preferably in aqueous suspension or solution, is added to the AMD waters, as well as the source of the AMD, such as the metal sulfides in the mined waste rocks. This will effectively promote crosslinking of the lipid coatings and inhibit the oxidation of the metal sulfides, as well as treat any existing AMD.

The amount of contact time between the chemical initiator and the non-crosslinked lipid-coated metal sulfide-containing material to ensure crosslinking of the coating as required by the present invention may vary, depending on the environmental factors present at the time of the experiment. The contact time may be less than 5 minutes, between 5 and 15 minutes, between 15 and 30 minutes, between 30 minutes and 1 hour, between 1 hour and 5 hours, between 5 hours and 1 day, between 1 day and 3 days, between 3 days and 7 days, between 7 days and 14 days, between 14 days and 1 month, between 1 month and 3 months, between 3 months and 1 year, or any fraction or multiple thereof. The required amount of time of contact between the chemical initiator and the non-crosslinked lipid-coated metal sulfide-containing material may be estimated by those skilled in the art based on sampling of the lipid-coated metal sulfide-containing material and determination of the extent of crosslinking in the coating using the methods known in the art and/or disclosed in the present application. Along with the contact between the chemical initiator and the non-crosslinked lipid-coated metal sulfide-containing material, there may be mixing of the chemical initiator and the lipid-coated metal sulfide-containing material. This mixing may be take place at the same time that the chemical initiator is introduced or may take place afterwards. The mixing may involve a mechanical stirrer or similar mechanical mixing device, use vibration devices, or involve other methods, such as passing forced air or forced liquid through the material under treatment.

Alternatively, the invention also envisions that the lipid composition of the invention may first be brought into contact directly with a composition comprising a chemical initiator. The chemical initiator, whether liquid or solid, is preferably suspended, dispersed, or dissolved into an aqueous solution (such as water, an aqueous solution of dilute acid, an aqueous solution of dilute base or an aqueous solution of salt, or a combination thereof) so that it may be more easily handled during application. The chemical initiator may also be suspended, dispersed, or dissolved into an aqueous solution containing some organic solvent, as long as the content of organic solvent does not prevent reaction of the chemical initiator with the lipid and does not significantly disrupt the subsequent binding of the crosslinked lipid to the surface of the metal sulfide-containing material.

Generally, an effective amount of the chemical initiator to be added to the lipid dispersion is an amount sufficient to promote appropriate crosslinking of the hydrophobic tails of the lipid. As such, the amount of the chemical initiator to be added to the lipid may vary widely, based on the nature of the lipid and its crosslinking groups used, the degree of crosslinking desired, and the concentration of the chemical initiator. One skilled in the art should be able to determine a preferred ratio between lipid and chemical initiator. Preferably, at least about 100 ml of the aqueous solution of the chemical initiator is added per liter of lipid dispersion in order to achieve the desired treatment, which is crosslinking the hydrophobic chains. Depending on the compositions used, this value can significantly vary. The amount of contact time between the chemical initiator and the lipid dispersion to ensure crosslinking of the lipid tails as required by the present invention may vary, depending on the environmental factors present at the time of the experiment. The contact time may be less than 5 minutes, between 5 and 15 minutes, between 15 and 30 minutes, between 30 minutes and 1 hour, between 1 hour and 5 hours, between 5 hours and 1 day, between 1 day and 3 days, between 3 days and 7 days, between 7 days and 14 days, between 14 days and 1 month, between 1 month and 3 months, between 3 months and 1 year, or any fraction or multiple thereof. The required amount of time of contact between the chemical initiator and the lipid dispersion may be estimated by those skilled in the art based on sampling of the mixture and determination of the extent of crosslinking in the lipid tails using the methods known in the art and/or disclosed in the present application. Crosslinking may take place during the time of contact of the lipid composition and the chemical initiator, or at any time thereafter. Along with the contact between the chemical initiator and the lipid dispersion, there may be mixing of the chemical initiator and the lipid dispersion. This mixing may be take place at the same time that the chemical initiator is introduced or may take place afterwards. The mixing may involve a mechanical stirrer or similar mechanical mixing device, use vibration devices, or involve other methods, such as passing forced air or forced liquid through the material under treatment.

After the lipid dispersion is contacted with the chemical initiator to allow for crosslinking of the lipid tails, the resulting composition may be contacted with the metal sulfide, with the source of the AMD, i.e., the metal sulfide-containing material, or with the AMD waters. The dispersion resulting from the treatment of the lipid dispersion with the chemical initiator dispersion may be used as such, or may be further suspended, dispersed, or dissolved into an aqueous solution (such as water, an aqueous solution of dilute acid, an aqueous solution of dilute base or an aqueous solution of salt, or a combination thereof) so that it may be more easily handled during application. The dispersion resulting from the treatment of the lipid dispersion with the chemical initiator dispersion may also be suspended, dispersed, or dissolved into an aqueous solution containing some organic solvent, as long as the content of organic solvent does not prevent reaction of the metal sulfide-containing material with the crosslinked lipid and does not significantly disrupt the structure of the lipid on the surface of the metal sulfide-containing material. The contact of the composition comprising the crosslinked lipid with the metal sulfide-containing material may be implemented by any known means of applying a solution including, but not limited to, injecting, spraying and pouring. In working with powdered or granular waste as the metal sulfide-containing material, it is preferable to add the crosslinked lipid composition of the invention to a water-based slurry of the waste. This may improve contact and dispersion of the lipid(s) among the waste. Preferably, an effective amount of the crosslinked lipid composition of the invention is suspended, dispersed, and/or dissolved in the aqueous or partially aqueous solution, so that a concentration of from about 10 micromolar to about 30 millimolar of the lipid is present in the liquid to be used in the preparation of the oxidation-inhibiting lipid coatings of the present invention. Generally, an effective amount of the crosslinked lipid composition of the present invention to be added to the metal sulfide-containing material and/or the AMD waters or other aqueous sources is an amount sufficient to interact with most or all reactive sites of the metal sulfide compounds in the metal sulfide-containing material. As such, the amount of the lipid coating to be applied directly to the metal sulfide-containing material or the area in need of treatment will vary widely, and may be determined to the person skilled in the art, based on the surface area to be treated, the volume of material to be treated, the pH of the material to be treated, the overall moisture level in the material to be treated and the concentration of the crosslinked lipid composition of the invention. Regarding the treatment of the metal sulfide-containing material, an amount of the crosslinked lipid composition of the invention to be used should be sufficient to prevent AMD from occurring. Preferably, at least about 250 ml of the aqueous dispersion containing about 10 micromolar to about 30 millimolar crosslinked lipid is added per liter of AMD water to be treated in order to achieve the desired treatment, which is preventing further AMD and inhibiting the oxidation of the metal sulfides. More preferably, a 1:1 ratio of aqueous crosslinked lipid-containing system to AMD water is used. Depending on the compositions used, this value can significantly vary. Similar amounts can be employed in treating the source of AMD (e.g., mine waste rocks such as pyrite). Accordingly, in preventing AMD from occurring or stopping any existing AMD, the crosslinked lipid compositions of the present invention, preferably in aqueous solution or suspensions, are added to the AMD waters, as well as the source of the AMD, such as the metal sulfides in the mined waste rocks. This will effectively inhibit the oxidation of the metal sulfides as well as treat any existing AMD.

The amount of contact time between the crosslinked lipid composition of the invention and the metal sulfide-containing material to ensure proper coating of the metal sulfide-containing material, as required by the present invention, may vary depending on the environmental factors present at the time of the experiment. The contact time may be less than 5 minutes, between 5 and 15 minutes, between 15 and 30 minutes, between 30 minutes and 1 hour, between 1 hour and 5 hours, between 5 hours and 1 day, between 1 day and 3 days, between 3 days and 7 days, between 7 days and 14 days, between 14 days and 1 month, between 1 month and 3 months, between 3 months and 1 year, or any fraction or multiples thereof. The required amount of time of contact between the crosslinked lipid composition of the invention and the metal sulfide-containing material may be estimated by those skilled in the art, based on sampling of the metal sulfide-containing material and determination of extent of coating of the metal sulfide-containing material using the methods known in the art and/or disclosed in the present application. Along with the contact between the metal sulfide-containing material and the crosslinked lipid composition of invention, there may be mixing of the metal sulfide-containing material and the crosslinked lipid composition of the invention. This mixing may be take place at the same time that the crosslinked lipid composition of the invention is introduced or may take place afterwards. The mixing may involve a mechanical stirrer or similar mechanical mixing device, use vibration devices, or involve other methods, such as passing forced air or forced liquid through the material under treatment.

After coating the metal sulfide-containing material with the crosslinked lipid coating according to any of the embodiments described above or any variations thereof,environmentally acceptable disposal of this waste product is made possible through stabilization. Specifically, for as long as the coating remains sound and it does so even in the acid environment characteristic of mining sites and spoil compounds, oxidation of the metal sulfide-containing materials by atmospheric oxygen and water is substantially prevented. As a result, the acid drainage and heavy metal pollution problems should be virtually eliminated.

As discussed above, and as one skilled in the art would readily appreciate, the metal sulfide-containing material, i.e., the source of the AMD, such as pyrite and marcasite, may also be coated by the present method in situ. More specifically, applying to the metal sulfide-containing material, as described above, an effective amount of the lipid composition comprising a two-tail lipid, wherein at least one hydrophobic tail of the two-tail lipid contains one or more crosslinkable group, followed by an effective amount of chemical initiator, should achieve this goal. Alternatively, reacting an effective amount of the lipid composition comprising a two-tail lipid, wherein at least one hydrophobic tail of the two-tail lipid contains one or more crosslinkable group, with an effective amount of a chemical initiator, followed by application of the resulting composition to the metal sulfide-containing material should also achieve this goal. Advantageously, the resulting crosslinked lipid coating of the metal sulfide-containing material generated in situ reduces or prevents the oxidation process from occurring, thereby reducing or preventing the production of acid solutions enriched with heavy metals.

This process can also be used in waters other than AMD waters, such as any aqueous source containing a metal sulfide in which oxidation inhibition is desired.

Although the invention has been described in its preferred form with a certain degree of particularity, obviously many changes and variations are possible therein and will be apparent to those skilled in the art after reading the foregoing description. For example, the coatings of the present invention may also be useful as a water repellent and/or corrosion protective coating when applied to surface that come into contact with water and oxygen such as wood decks, wood or metal railings, wood or metal fences and the like. It is therefore to be understood that the present invention may be presented otherwise than as specifically described herein without departing from the spirit and scope thereof.

### EXAMPLES

The invention is described hereafter with reference to the following examples. The examples are provided for the purpose of illustration only and the invention should in no way be construed as being limited to these examples, but rather should be construed to encompass any and all variations that become evident as a result of the teaching provided herein.

### Materials

Pyrite crystals were purchased from Wards Natural Science (Rochester, N.Y.) and crushed into pyrite powder. BET measurements indicated that the pyrite powder had a surface area of approximately 0.75 m²/g (Brunauer et al., 1938, “Adsorption of gases in multimolecular layers”, J. Am. Chem. Soc. 60, pp. 309-319).

Pyrite cubes for atomic force microscopy (AFM) experiments were cut from the crystals using a diamond saw. Pyrite plates were then reshaped by a common saw to fit inside the flow cell with a diameter of 1.5 cm for AFM experiments. Both pyrite powder and pyrite plates were sterilized by autoclave and subsequently washed with 1.0 M deoxygenated HCl solution in a nitrogen gas environment. The pyrite was then rinsed with deoxygenated deionized water and dried under a flow of nitrogen gas.

The phospholipids 1,2-bis(10,12-tricosadiynoyl)-sn-glycero-3-phosphocholine (also known as 23:2 PC Diyne) and egg phosphocholine (also known as egg PC) were purchased from Avanti Polar Lipids (Alabaster, Ala.). Typical phospholipid dispersions were prepared by adding 40 mg lipid to 40 ml deionized water, followed by sonication in a 70° C. water bath for 2.5 hours. Lipid suspensions of 0.2 mM concentration were prepared by dilution of the initial suspension.

The chemical reagents sodium bisulfite (NaHSO₃) and potassium peroxodisulfate (K₂S₂O₈) were obtained from Sigma-Aldrich (St. Louis, Mo.). Throughout the experiments, 0.02 mM solutions of each of the initiators (generally in 5 mL volumes) were used.

The organisms Acidithiobacillus ferrooxidans (23270) and Acidiphilum acidophilum (27807) were obtained from ATCC (Manassas, Va.). The growing media were prepared following a protocol published on ATCC (Hao et al., 2006, “The effect of adsorbed lipid on pyrite oxidation under biotic conditions”, Geochem. Trans. 7-8). Cultures used for experiments were grown unshaken in 100 ml batches in 250 ml autoclaved Erlenmeyer flasks. Bacteria for the experiments were harvested at the early stationary phase of growth (approximately 8 days of growth) by double filtration. Cell counts were performed using epifluorescence microscopy as described by Hao et al. (“The effect of adsorbed lipid on pyrite oxidation under biotic conditions”, Geochem. Trans 2006: 7-8). Bacteria densities were determined using a protocol published elsewhere (Sherr et al., 2001, “Enumeration of total and highly active bacteria”, Mar. Microbiol. 30, 129-159; Muyer et al., 1987, “A combination immunofluorescence-DNA-fluorescence staining technique for enumeration of Thiobacillus ferrooxidans in a population of acidophilic bacteria”, App. Environ. Microbiol. 53, 660-664).

The concentration of aqueous iron resulting from pyrite dissolution was determined using the ferrozine technique, where complexation of a Fe(II) ion with three ferrozine ligands gives a UV absorbance maxima at 562 nm. Any Fe(III) present in solution was reduced to Fe(II) using ascorbic acid, prior to running the assay. A Perkin-Elmer UV-Visible spectrometer was used to carry out these measurements. Error bars were calculated on the basis of multiple trials of duplicate samples.

Attenuated Total Reflection Fourier Transform Infrared (ATR-FTIR) was performed using a Nicolet 6700 spectrometer with a DTGS detector and Thermo Electron Smart Orbit™ single-bounce diamond ATR accessory. Spectra were collected with 4 cm⁻¹ resolution.

### Comparative Example 1

### Preparation of Non-Crosslinked and Crosslinked Liposomes.

A suspension of lipid 23:2 PC diyne (30 mL, 0.2 mM) was sonicated for 30 minutes at room temperature, in order to create small unilaminar vesicles and improve the homogeneity of lipid vesicles. Then, solutions of NaHSO₃ (5 mL of 0.02 mM) and K₂S₂O₈ (5 mL of 0.02 mM) were added to the lipid suspension and the system was stored at room temperature for 10 hours. The resulting product may be described as “chemically crosslinked 23:2 PC diyne liposome”.

In a parallel experiment, non-crosslinked liposomes were generated. A suspension of lipid 23:2 PC diyne (30 mL, 0.2 mM) was sonicated for 30 minutes at room temperature, without addition of chemical initiators. The resulting product may be described as “non-crosslinked 23:3 PC diyne liposome”.

In another parallel experiment, liposomes were prepared with egg PC, which contains no unsaturated bond in the hydrophobic tails. A suspension of egg PC lipid (30 mL, 0.2 mM) was sonicated for 30 min at room temperature, and then treated with solutions of NaHSO₃ (5 mL of 0.02 mM) and K₂S₂O₈ (5 mL of 0.02 mM). The resulting product may be described as “egg PC liposome”.

### Comparative Example 2

### Qualitative Evaluation of Liposomes.

The properties of 23:3 PC diyne liposomes cross-linked by UV light, 23:3 PC diyne liposomes crosslinked by chemical initiators, non-crosslinked 23:3 PC diyne liposomes, and egg PC liposomes were compared. For each system, 0.2 mM suspensions were placed in separate glass containers, chloroform was added, and the systems were stored at room temperature for 5 days. The systems were then vortexed for 30 seconds and photographed.

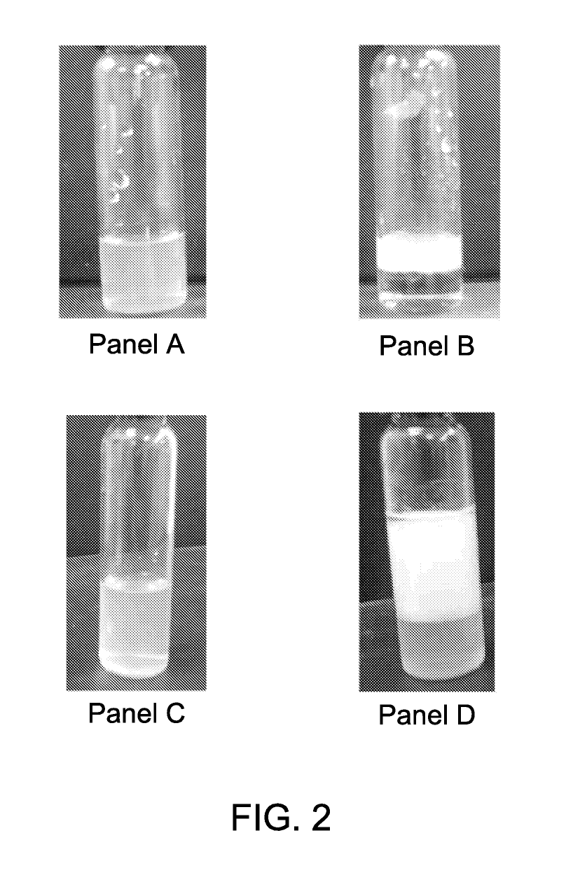

The results of this experiment are represented in FIG. 2. Panel A in FIG. 2 shows non-crosslinked 23:3 PC diyne liposomes (3 mL of 0.2 mM liposome suspension, and 4 mL chloroform). Panel B in FIG. 2 shows 23:3 PC diyne liposomes crosslinked by chemical initiators (3 mL of 0.2 mM liposome suspension, and 4 mL chloroform). The clear chloroform layer (lower layer) in Panel B shows that the crosslinked lipid was no longer soluble in chloroform solution, suggesting that the physical properties of the lipid changed after the crosslinking. Furthermore, the majority of the crosslinked lipid vesicles remained in the upper water layer (Panel B) even after intense vortexing, whereas a single phase was observed immediately after vortexing in the non-crosslinked material (Panel A).

Panel C in FIG. 2 shows egg PC liposome treated with chemical initiators (3 mL of 0.2 mM liposome suspension, and 6 mL chloroform). The egg PC liposome formed a virtually homogeneous suspension following vortexing, in similar fashion to the non-crosslinked 23:3 PC diyne liposomes. The fact that the result with the egg PC liposome treated with chemical initiators was visually identical to the result obtained with egg PC liposome untreated with chemical initiators (results not shown) suggests that addition of chemical initiators did not lead to any change in the egg PC liposome.

Panel D in FIG. 2 shows 23:3 PC diyne liposomes crosslinked by UV radiation (7 mL of 0.2 mM liposome suspension, and 5 mL chloroform). Evaluation of the turbidity of this vial suggests that the crosslinking efficiency by UV irradiation was possibly lower than 80%. On the other hand, evaluation of the turbidity of the 23:3 PC diyne liposomes crosslinked by UV radiation (Panel B) could be higher than 90%.

### Comparative Example 3

### ATR-FTIR Analysis of Liposomes.

The degree of crosslinking of 23:3 PC diyne liposomes by chemical initiators was evaluated by Attenuated Total Reflection Fourier Transform Infrared Spectroscopy (ATR-FTIR). For that, separate suspensions of chemically crosslinked 23:2 PC diyne liposomes and non-crosslinked 23:2 PC diyne liposome (200 μL of 0.2 mM suspensions) were deposited on the diamond ATR window of the FTIR instrument. The lipid was dried using a nitrogen gas flow, and lipid spectra were collected.

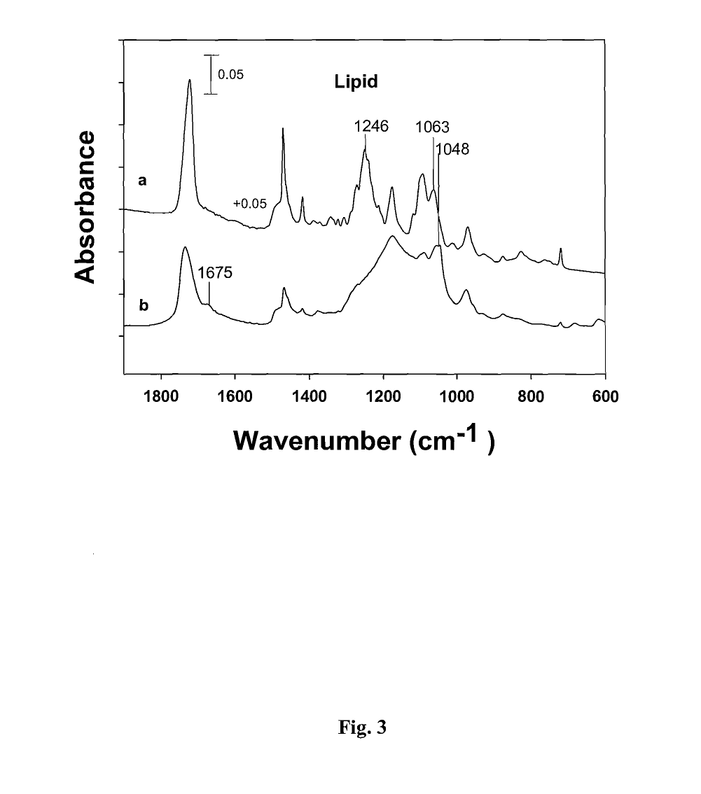

Results of these experiments are shown in FIG. 3. The spectral region between 600 cm⁻¹ and 1900 cm⁻¹ showed differences between the non-crosslinked liposomes (top trace) and chemically crosslinked liposomes (bottom trace). A shoulder peak around 1675 cm⁻¹, characteristic of a C═C group, appeared after crosslinking, suggesting that a C═C bond is formed as part of the crosslinking process. Another important observation in the crosslinked material is that the peak for the group PO₂⁻shifted from 1063 cm⁻¹ to 1048 cm⁻¹, indicating a structural change induced by the lipid crosslinking process. The decrease in intensity of the PO₂⁻ associated peak around 1246 cm⁻¹ may also indicate a structural rearrangement in the crosslinked liposome. The detailed vibration modes are listed in Table 1.

TABLE 1
Assignment of the IR Absorbance of Lipid 23:2 PC diyne.

| Frequency (cm⁻¹) | Grope Vibrations | Assignment | Reference |
|---|---|---|---|
| 1725 | Carbonyl | ν (C═O) | (A) |
| 1675 | Alkenes | ν (C═C) | (B) |
| 1470 | Methylene | δ (CH₂) scissoring | (A) |
| 1246 | Phosphate | ν a (PO₂⁻) | (A), (C) |
| 1170 | Ester | ν a (C—O) | (D) |
| 1090 | Phosphate | ν s (PO₂⁻) | (E) |
| 1064 | Phosphate ester | ν (C—O—PO₂⁻) | (F) |
| 970 | Choline | ν a (N⁺(CH₃)₃) | (A) |
| 722 | Methylene | δ r (CH₂) | (A) |

Legends for FIG. 1:
(A) Binder et al., 1997, J. Phys. Chem. B 101, 6618-6628.
(B) Stuart, 2004, “Infrared Spectroscopy: Fundamentals and Applications”, John Wiley & Sons.
(C) Pohle & Selle, 1996, Chem. & Phys. Lip. 82 (2), 191-198.
(D) Hunt et al., 1989, J. Mol. Struct. 214, 93-109.
(E) Stephensa & Dluhy, 1996, Thin Solid Films 284-285 (15), 381-386.
(F) Hubner & Blume, 1998, Chem. & Phys. Lip. 96 (1-2, 99-123.

### Comparative Example 4

### Pyrite Oxidation in the Absence of Lipid Coating.

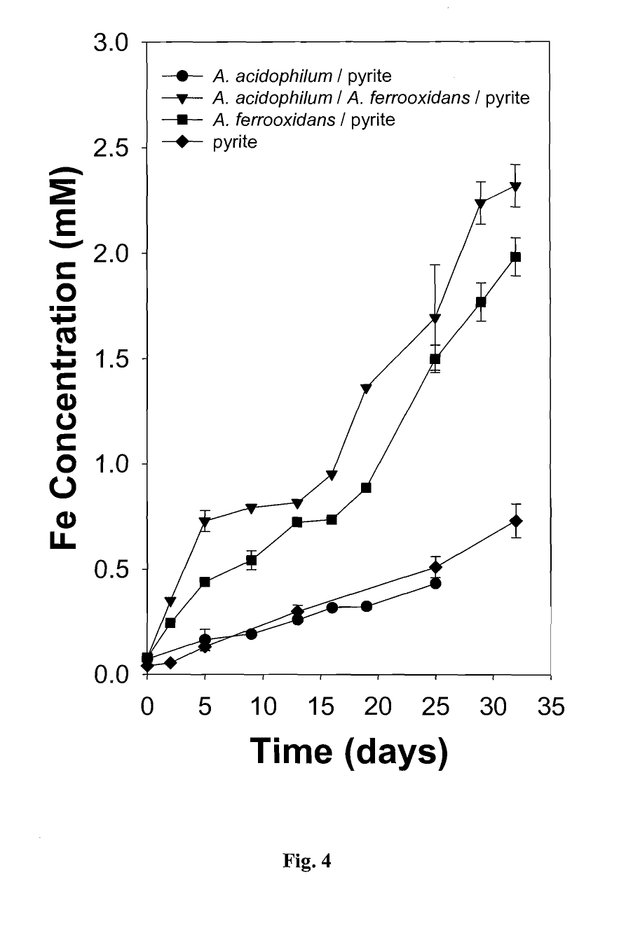

Batch experiments were conducted to monitor abiotic and biotic pyrite oxidation in the absence of lipid coating. FIG. 4 plots aqueous iron concentration (determined using the ferrozine technique) versus time for different samples of pyrite: (a) pyrite by itself, (b) pyrite exposed to the organism A. ferrooxidans, (c) pyrite exposed to the organism A. acidophilum, and (d) pyrite exposed to the organisms A. ferrooxidans and A. acidophilum.

Initial cell densities for A. ferrooxidans were 8.3×10⁷ cells/mL for sample (b) and 7.8×10⁷ cells/mL for sample (d). Initial cell densities for A. acidophilum were 8.8×10⁹ cells/mL for sample (c), and 7.2×10⁹ cells/mL for sample (d). The initial amount of pyrite was 0.1 g in a total volume of 30 mL at an initial pH of 2.

As evidenced in FIG. 4, pyrite in abiotic conditions and pyrite in the presence of A. acidophilum had similar low rate of dissolution, but dissolution was greatly increased in the presence of A. ferrooxidans. Dissolution rate in the presence of with A. ferrooxidans was high, independent from the presence of A. acidophilum as well.

### Comparative Example 5

### Pyrite Oxidation in the Presence of Non-Crosslinked Lipid Coating

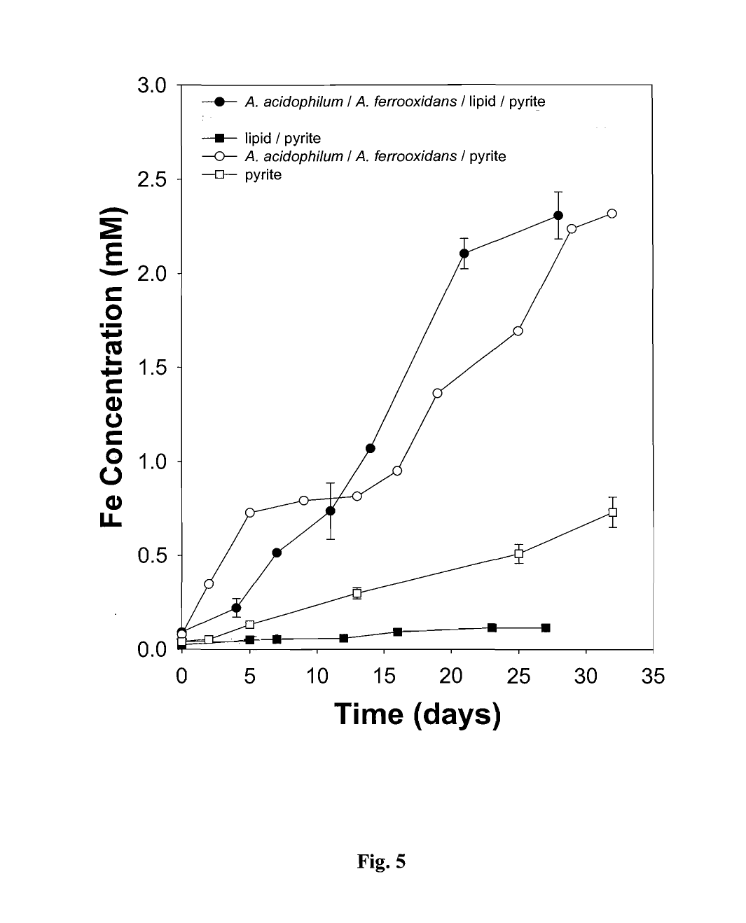

Batch experiments were conducted to monitor abiotic and biotic pyrite oxidations in the presence of non-crosslinked lipid. FIG. 5 plots aqueous iron concentration (determined using the ferrozine technique) versus time for different samples of pyrite: (a) pyrite by itself, (b) pyrite exposed to the organisms A. ferrooxidans and A. acidophilum, (c) pyrite pretreated with non-crosslinked lipid (non-crosslinked lipid-coated pyrite), and (d) non-crosslinked lipid-coated pyrite further exposed to the organisms A. ferrooxidans and A. acidophilum.

Initial cell densities for A. ferrooxidans and A. acidophilum were, respectively, 8.58×10⁸ cells/mL and 2.9×10⁸ cells/mL for both samples (b) and (d). The initial amount of pyrite was 0.1 g in a total volume of 30 mL at an initial pH of 2.

As evidenced in FIG. 5, lipid-treated pyrite showed significantly less oxidation than pyrite alone, indicating that the lipid coating protected pyrite from the acidic environment. However, dissolution levels were similarly high for pyrite by itself, and non-crosslinked lipid-coated pyrite in the presence of mixed communities of A. ferrooxidans and A. acidophilum after 30 days. This result suggests that A. ferrooxidans and/or A. acidophilum have the ability to weaken the shielding effect of the lipid coating on the pyrite sample, allowing pyrite dissolution under the assay conditions. One possibility is that the heterotrophic organism A. acidophilum may process the lipid coating for its own metabolic needs, removing it entirely or partially from pyrite.

### Example 1

### Atomic Force Microscopy Analysis: Ex Situ Formation of Lipid Coating on Pyrite.

Atomic Force Microscopy (AFM) provides three-dimensional profiles of particles on substrates, allowing better understanding of the crosslinking of lipids on solids. Tapping mode AFM images in aqueous condition, maintained via a flow cell, were obtained using a PicoSPM II (Molecular Imaging) microscope equipped with a 100 μm multipurpose scanner. The flow cell had two channels. The inlet channel allowed pumping of lipid or other liquids to the sample, the outlet channel allowed the excess of liquid to flow away. The probes used in all the AFM measurements (NSC14, μtMasch) had a 125 μm cantilever, a nominal force constant of 5 N/m, and a resonant frequency of 160 kHz. Scan rates ranged from 1-3 Hz with 512 sampling points per scan line. Pyrite with attached lipid was first secured inside the flow cell and then imaged in aqueous conditions.

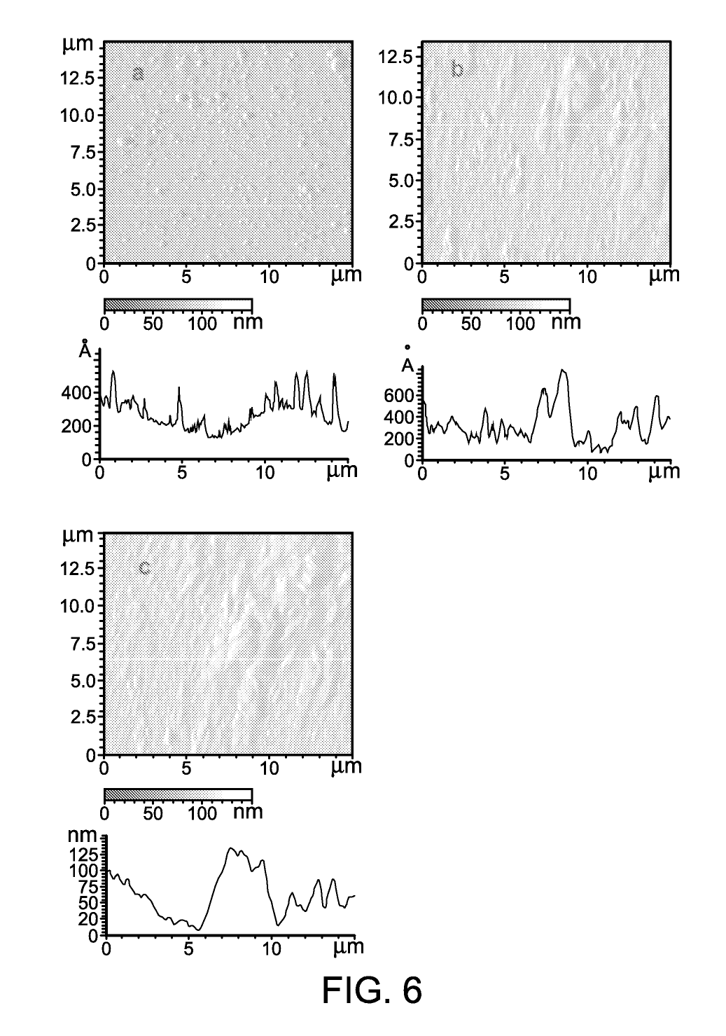

The results on experiments involving ex situ lipid structure formation on pyrite, before and after the crosslinking process, are represented in FIG. 6. Panel A of FIG. 6 represents pyrite exposed with a suspension of 23:2 PC diyne lipid for 24 hours. Panel B of FIG. 6 represents pyrite treated with a suspension of 23:2 PC diyne and then exposed to a solution of sodium bisulfite and sodium peroxodisulfate for 1 day. Panel C of FIG. 6 represents pyrite treated with a suspension of 23:2 PC diyne and then exposed to a solution of sodium bisulfite and sodium peroxodisulfate for 2 days. Comparison of Panels A-C in FIG. 6 indicates that non-crosslinked lipid formed a larger number of small and regular (especially round-shaped) structures on the pyrite surface than did the crosslinked lipid. Crosslinked lipid structures were more elongated (Panels B and C) in general, and tended to be more closely packed together than the non-crosslinked lipid structures on pyrite. Surface coverage of pyrite reached at least 75% after only the one-day incubation, and increased to 90% after the two-day incubation.

Another observation is that crosslinked lipid structures were significantly larger (20-100 nm) than non-crosslinked lipid structures (10-20 nm). The large size of these particles suggests that, under the experimental conditions, crosslinked bilayer and multilayer structures may have been formed.

### Example 2

### Atomic Force Microscopy Analysis: In Situ Formation of Lipid Coating on Pyrite.

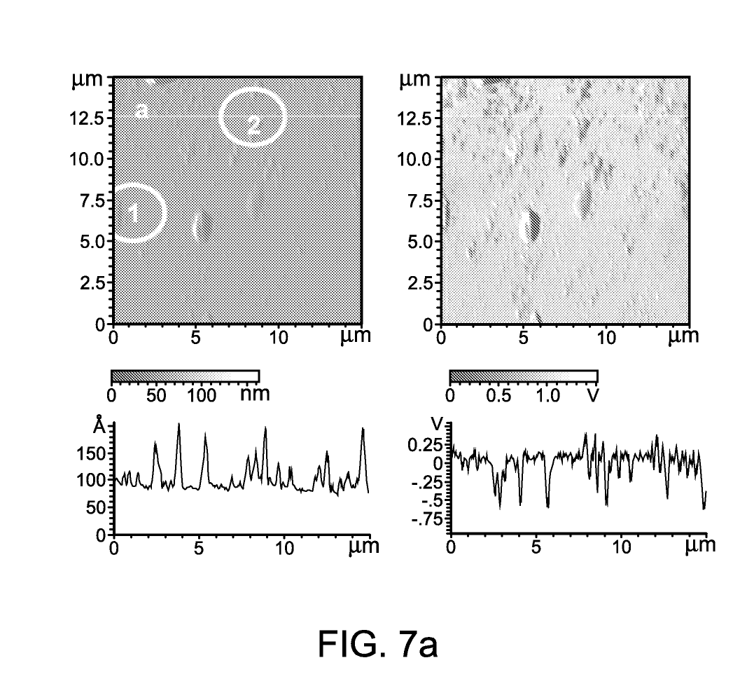

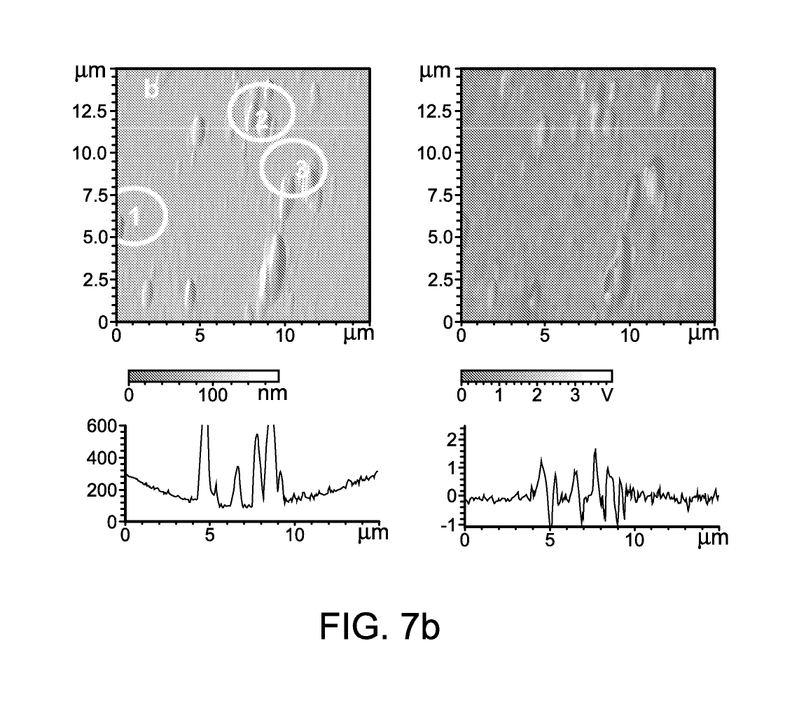

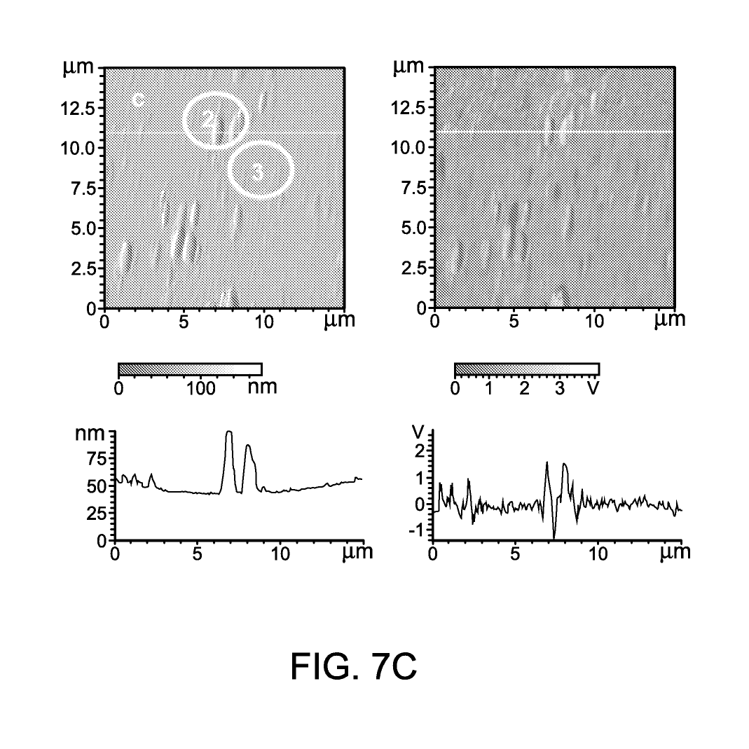

In situ AFM experiments were performed to investigate the detailed polymerization process of the lipid on pyrite. The results are summarized in FIGS. 7a, 7b and 7c. FIG. 7a shows a pyrite platelet after a two-day exposure to 10 mL of 23:2 PC diyne lipid. FIG. 7b shows the system 20 minutes after the introduction of a solution of sodium bisulfite and sodium peroxodisulfate. FIG. 6c shows the system 40 minutes after the introduction of a solution of sodium bisulfite and sodium peroxodisulfate. Solution flow rate through the AFM cell was 0.2 mL/min. In FIG. 7 the images on the left are amplitude images, and the images on the right are phase images.

FIG. 7a shows the presence of many bilayer and some multilayer structures on pyrite surface. Analysis of the phase image of FIG. 7a also indicates that the surface coverage of pyrite reached at least 80%. Successive images taken after the addition of the chemical initiators clearly showed the reorganization and rearrangement of lipid structures on pyrite surface. FIG. 7b shows that some elongated structures were formed on the pyrite surface. These oval and long features may be attributed to the crosslinking of lipid vesicles by the chemical initiators. The phase image of FIG. 7b suggests that a seemingly random loss of lipid vesicles occurs in some areas, leading the surface coverage down to approximately 70%. Analysis of lipid structure heights showed that particles as large as 60 nm were formed within a rather short time (20 minutes), and these particles were significantly larger than any lipid particles formed on pyrite prior to the introduction of the chemical initiators. Taken together, these observations suggest a crosslinking process was triggered by introduction of the chemical initiators.

FIGS. 7a, 7b and 7c also provide insight into the reconstruction of lipid structures on pyrite. The three images in FIG. 7 refer to approximately the same area under analysis, and circles numbered 1-3 act as spatial markers. The absence of circle 1 in FIG. 6c is due to a scanning shift after 40 minutes. Comparison of circle 3 in FIGS. 7b and 7c suggests that most crosslinked structures were mobile during the reconstruction process. Size increases for crosslinked structures may be attributed to the coalescence of lipid structures from the different areas of the substrate. Beyond 40 minutes, no obvious change in the image was observed (result not shown). This experiment indicates that introduction of the chemical initiators mobilized lipid structures and caused them to undergo crosslinking and form crosslinked structures. The low concentration of lipid particles in this experiment prevented the observation of the large structures shown in the ex situ AFM experiment.

The AFM experiments provided additional information on the changes in physical properties of the lipid before and after exposure to the chemical initiators. Analysis of the phase images in FIGS. 7a, 7b and 7c shows that crosslinked lipid particles exhibited brighter contrast and an obvious positive phase shift as compared to non-crosslinked lipid particles, indicating physical property changes in the polymerized lipid particles, such as stiffer surfaces.

Taken together, the AFM experiments are consistent with a lipid coating model as described below. Prior studies have shown that the phosphate group in the lipid head group binds to the pyrite surface (results not shown). Crosslinking of the lipid by the chemical initiator produces physically stiffer and presumably more impermeable lipid layers on the pyrite surface, suggesting an intermolecular (rather than intramolecular) polymerization process. This intermolecular mechanism is also supported by the AFM images, in which evidence of bilayer- and multilayer-lipid structures was observed after the polymerization process. The observation of bilayer and multilayer structures also indicated a very high efficacy in the chemically induced polymerization of the lipid.

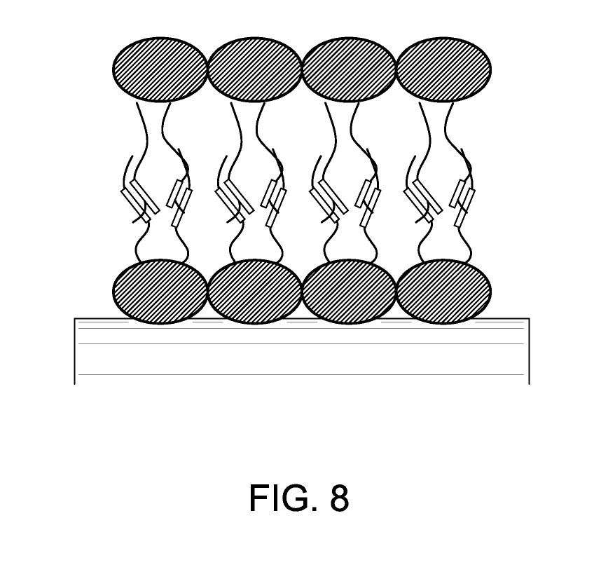

While not wishing to be bound by theory, the results summarized above may be used to create a working model of lipid polymerization, as depicted in FIG. 8. Initially, the hydrophilic lipid head group may bind to the pyrite surface, and then the triple bonds in the diacetylene group of the hydrophobic tail of the lipid take part in an intramolecular crosslinking event to form a bilayer lipid. Multilayer lipid structures may also be formed via similar mechanisms. This model is only intended for visualization purposes and does not limit the scope of the invention in any manner or aspect.

### Example 3

### Pyrite Oxidation in the Presence of Crosslinked Lipid Coating.

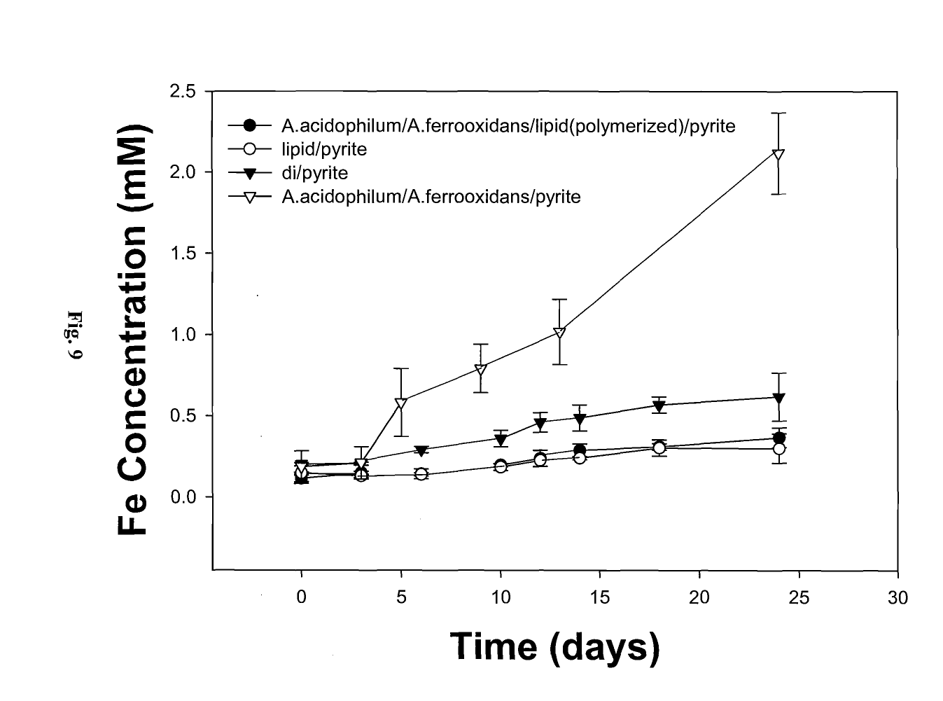

Batch experiments were conducted to monitor abiotic and biotic pyrite oxidations in the presence of crosslinked lipid coating. FIG. 9 plots aqueous iron concentration (determined using the ferrozine technique) versus time for different samples of pyrite: (a) pyrite by itself, (b) pyrite exposed to the organisms i A. ferrooxidans and A. acidophilum, (c) pyrite precoated with crosslinked lipid (crosslinked lipid-coated pyrite), and (d) crosslinked lipid-coated pyrite further exposed to A. ferrooxidans and A. acidophilum. An increase in the amount of aqueous iron in solution corresponds to increasing amounts of pyrite oxidation.

Initial cell densities for A. ferrooxidans and A. acidophilum were, respectively, 1.75×10⁸ cells/mL and 4.53×10⁸ cells/mL for sample (b), and 2.02×10⁸ cells/mL and 4.77×10⁸ cells/mL for sample (d). The bacterial densities in all batch experiments experienced an average of 35% increase over the experimental period. The initial amount of pyrite was 0.125 g in a total volume of 30 mL at an initial pH of 2.

As evidenced in FIG. 9, treatment of pyrite with A. acidophilum & A. ferrooxidans showed the greatest degree of pyrite oxidation over 24 days of monitoring. Rates of pyrite oxidation, based on calculations of aqueous iron production rates, are summarized in Table 2. Linear regression methods yielded a rate of 1.09×10⁻⁸ M s⁻m⁻² and 3.2×10⁻⁹ M s⁻¹m⁻² for pyrite treated with the two microorganisms and for pyrite alone, respectively. Furthermore, FIG. 9 shows that the concentration of aqueous iron resulting from pyrite oxidation was at least 6 times greater after 24 days in the sample of pyrite containing both A. ferrooxidans and A. acidophilum than in the sample containing crosslinked lipid-coated pyrite in the presence of bacteria. These results suggest that polymerized lipid was capable of suppressing pyrite oxidation in the presence of both iron-oxidizing bacteria and heterotrophic bacteria.

TABLE 2
Pyrite oxidation rates.

| | | Aqueous iron | |
|---|---|---|---|
| | | production rate | |
| | Amount of | (10⁻⁸ M · | % sup- |
| Samples | lipid | s⁻¹ · m⁻²) | pression |
| Pyrite | NA | 0.32 | NA |
| crosslinked lipid-coated pyrite | 1 μmol | 0.15 | 86 |
| pyrite with A. ferrooxidans and A. | NA | 1.09 | NA |
| acidophilum | | | |
| crosslinked lipid-coated pyrite | 1 μmol | 0.18 | 83 |
| with A. ferrooxidans and A. | | | |
| acidophilum | | | |

Furthermore, FIG. 9 indicates that the degree of pyrite oxidation was similar for cross-linked lipid-coated pyrite exposed to both A. acidophilum & A. ferrooxidan, and cross-linked lipid-coated pyrite alone. This result highlights the fact that the crosslinked lipid coating significantly suppressed pyrite oxidation. Interestingly, the amount of pyrite oxidation for cross-linked lipid-coated pyrite in the presence of A. acidophilum & A. ferrooxidan is even lower than that of pyrite by itself This observation is consistent with the stiffer, and presumably less penetrable, surface observed for the crosslinked lipid-coated pyrite by AFM phase date.

Comparative Example 5 showed that non-crosslinked lipid coatings were not capable of suppressing pyrite oxidation in the presence of the heterotrophic bacterium A. acidophium (presumably because this bacterium consumes the lipid as a carbon source). Based on the results shown in FIG. 9, it is reasonable to conclude that crosslinked lipid was able to withstand decomposition by heterotrophic bacteria, since the crosslinked lipid-coated pyrite showed similarly low dissolution rates by itself and in the presence of A. acidophilum & A. ferrooxidans.

Initial pyrite oxidation was reported to occur at Fe (III) bearing defect sites (Guevremont et al., 1998, “Reactivity of the (100) plane of pyrite in oxidizing gaseous ands aqueous environments: Effects of surface imperfections”, Environ. Sci. Technol. 32, 3743-3748). The lipid coating on pyrite has been shown to successfully suppress the electron transfer from Fe(II) via Fe(III) to oxygen (Hao et al., 2006). Considering that AFM results suggested that the crosslinking process caused the formation of a large percentage of lipid multilayers on pyrite surface, the crosslinked lipid coating may not span the whole surface of the pyrite solid. However, in the present Example the crosslinked lipid coating was able to prevent pyrite oxidation even in the presence of two microorganisms. Thus it may be possible that even partial coverage of the pyrite surface with crosslinked lipid coating prevents pyrite dissolution, presumably because the crosslinked lipid preferentially binds to the Fe(III) bearing defect sites where pyrite oxidation is initiated.

The disclosure of each and every patent, patent application, and publication cited herein is incorporated herein by reference in its entirety.

What is claimed:

1. A method for generating a crosslinked lipid coating on a metal sulfide-containing material to avoid oxidation of said metal sulfide-containing material, comprising either the steps of:
contacting said metal sulfide-containing material with an effective amount of a first liquid dispersion comprising a lipid composition comprising a two-tail lipid, wherein said two-tail lipid comprises a hydrophilic head group attached to two hydrophobic tails, wherein at least one of said two hydrophobic tails contains one or more crosslinkable groups, thereby providing a non-crosslinked lipid-coated metal sulfide-containing material; and,
contacting said non-crosslinked lipid-coated metal sulfide-containing material with an effective amount of a second liquid dispersion comprising a chemical initiator for promoting lipid crosslinking, thereby providing a crosslinked lipid-coated metal sulfide-containing material;
or the steps of:
contacting an effective amount of a first liquid dispersion comprising a lipid composition comprising a two-tail lipid, wherein said two-tail lipid comprises a hydrophilic head group attached to two hydrophobic tails, wherein at least one of said two hydrophobic tails contains one or more crosslinkable groups, with an effective amount of a second liquid dispersion comprising a chemical initiator for promoting lipid crosslinking, thereby providing a third liquid dispersion comprising a crosslinked lipid; and,
contacting said third liquid dispersion with said metal sulfide-containing material, thereby providing a crosslinked lipid-coated metal sulfide-containing material.

2. The method of claim 1, wherein said metal sulfide-containing material is selected from the group consisting of ore mine waste rock, coal repositories and metal sulfide tailings.

3. The method of claim 1, wherein said metal sulfide-containing material comprises one or more metal sulfides selected from the group consisting of pyrite, marcasite, arsenopyrite, argentite, chalcopyrite, cinnabar, galena, molybdenite, pentlandite, realgar, sphalerite, stibnite, and combinations thereof.

4. The method of claim 1, wherein said hydrophilic head group is selected from the group consisting of phosphate, phosphoryl, sulfate, amino, amine, carboxylate, hydroxyl, thiol, carbonyl, and combinations thereof.

5. The method of claim 1, wherein said one or more crosslinkable groups are selected from the group consisting of alkenyl and alkynyl groups.

6. The method of claim 5, wherein at least one of said one or more crosslinkable groups is diacetylenyl.

7. The method of claim 1, wherein said chemical initiator is selected from the group consisting of hydrogen peroxide equivalents, azocompounds, and redox systems.

8. The method of claim 7, wherein said hydrogen peroxide equivalents comprise a mixture of sodium bisulfate and sodium peroxodisulfate.

9. The method of claim 1, wherein said two hydrophobic groups are attached to said hydrophilic head group by an ether or ester bond.

10. The method of claim 1, wherein at least one of said two hydrophobic groups comprises a fatty acid moiety.

11. The method of claim 10, wherein said fatty acid moiety is selected from the group consisting of 10,12-tricosadiynoyl, myristoleoyl, myristelaidoyl, palmitoleoyl, palmitelaidoyl, petroselinoyl, oleoyl, elaidoyl, linoleoyl, linolenoyl, eicosenoyl, arachidonoyl, erucoyl, 4,7,10,13,16,19-(all-cis)-docosahexaenoic, and nervonoyl.

12. The method of claim 11, wherein said fatty acid moiety is 10,12-tricosadiynoyl.

13. The method of claim 1, wherein said two-tail lipid is 1,2-bis(10,12-tricosadiynoyl)-sn-glycero-3-phosphocholine.

14. The method of claim 1, wherein said lipid composition further comprises a lipid selected from the group consisting of phosphatidylcholine, phosphatidylethanolamine, phosphatidic acid, phosphatidylinositol, sphingomyelin, diacyl glycerol, phosphatidyl ethanolamine, diacylaminopropanediols, disteroylaminopropanediol, phosphatidylglycerol, distearyl phosphatidylcholine, egg sphingomyelin, 1,2-dipalmitoyl-sn-glycero-3-[phospho-L-serine], 1,2-dimyristoyl-sn-glycero-3-[phospho-rac-(1-glycerol)], 1,2-bis(10,12-tricosadiynoyl)-sn-glycero-3-phosphocholine, 1,2-di-O-octadecyl-sn-glycero-3-phosphocholine and combinations thereof.

15. The method of claim 1, wherein said lipid composition ranges in concentration from about 10 micromolar to about 30 millimolar in said first liquid dispersion.

16. The method of claim 1, wherein said chemical initiator ranges in concentration from about 3 micromolar to about 30 millimolar in said second liquid dispersion.

17. A method for treating acid mine drainage, comprising either the steps of:
contacting a source of said acid mine drainage with an effective amount of a first liquid dispersion comprising a lipid composition comprising a two-tail lipid, wherein said two-tail lipid comprises a hydrophilic head group attached to two hydrophobic tails, wherein at least one of said two hydrophobic tails contains one or more crosslinkable groups, thereby providing a non-crosslinked lipid-coated metal sulfide-containing material; and,
contacting said non-crosslinked lipid-coated metal sulfide-containing material with an effective amount of a second liquid dispersion comprising a chemical initiator for promoting lipid crosslinking, thereby providing a crosslinked lipid-coated acid mine drainage;
or the steps of:
contacting an effective amount of a first liquid dispersion comprising a lipid composition comprising a two-tail lipid, wherein said two-tail lipid comprises a hydrophilic head group attached to two hydrophobic tails, wherein at least one of said two hydrophobic tails contains one or more crosslinkable groups, with an effective amount of a second liquid dispersion comprising a chemical initiator for promoting lipid crosslinking, thereby providing a third liquid dispersion comprising a crosslinked lipid; and,
contacting said third liquid dispersion with said acid mine drainage, thereby providing a crosslinked lipid-coated acid mine drainage.

18. The method of claim 17, wherein said source of said acid mine drainage comprises a metal sulfide-containing material.

19. The method of claim 18, wherein said metal sulfide-containing material is selected from the group consisting of ore mine waste rock, coal repositories and metal sulfide tailings.

20. The method of claim 18, wherein said metal sulfide-containing material comprises one or more metal sulfides selected from the group consisting of pyrite, marcasite, arsenopyrite, argentite, chalcopyrite, cinnabar, galena, molybdenite, pentlandite, realgar, sphalerite, stibnite, and combinations thereof.

21. The method of claim 17, wherein said hydrophilic head group is selected from the group consisting of phosphate, phosphoryl, sulfate, amino, amine, carboxylate, hydroxyl, thiol, carbonyl, and combinations thereof.

22. The method of claim 17, wherein said one or more crosslinkable groups are selected from the group consisting of alkenyl and alkynyl groups.

23. The method of claim 22, wherein at least one of said one or more crosslinkable groups is diacetylenyl.

24. The method of claim 17, wherein said chemical initiator is selected from the group consisting of hydrogen peroxide equivalents, azocompounds, and redox systems.

25. The method of claim 24, wherein said hydrogen peroxide equivalents comprise a mixture of sodium bisulfite and sodium peroxodisulfate.

26. The method of claim 17, wherein said two hydrophobic groups are attached to said hydrophilic head group by an ether or ester bond.

27. The method of claim 17, wherein at least one of said two hydrophobic groups comprises a fatty acid moiety.

28. The method of claim 27, wherein said fatty acid moiety is selected from the group consisting of 10,12-tricosadiynoyl, myristoleoyl, myristelaidoyl, palmitoleoyl, palmitelaidoyl, petroselinoyl, oleoyl, elaidoyl, linoleoyl, linolenoyl, eicosenoyl, arachidonoyl, erucoyl, 4,7,10,13,16,19-(all-cis)-docosahexaenoic, and nervonoyl.

29. The method of claim 28, wherein said fatty acid moiety is 10,12-tricosadiynoyl.

30. The method of claim 17, wherein said two-tail lipid is 1,2-bis(10,12-tricosadiynoyl)-sn-glycero-3-phosphocholine.

31. The method of claim 17, wherein said lipid composition further comprises a lipid selected from the group consisting of phosphatidylcholine, phosphatidylethanolamine, phosphatidic acid, phosphatidylinositol, sphingomyelin, diacyl glycerol, phosphatidyl ethanolamine, diacylaminopropanediols, disteroylaminopropanediol, phosphatidylglycerol, distearyl phosphatidylcholine, egg sphingomyelin, 1,2-dipalmitoyl-sn-glycero-3-[phospho-L-serine], 1,2-dimyristoyl-sn-glycero-3-[phospho-rac-(1-glycerol)], 1,2-bis(10,12-tricosadiynoyl)-sn-glycero-3-phosphocholine, 1,2-di-O-octadecyl-sn-glycero-3-phosphocholine and combinations thereof.

32. The method of claim 17, wherein said lipid composition ranges in concentration from about 10 micromolar to about 30 millimolar in said first liquid dispersion.

33. The method of claim 17, wherein said chemical initiator ranges in concentration from about 3 micromolar to about 30 millimolar in said second liquid dispersion.

34. A composition comprising a metal sulfide-containing material, wherein a crosslinked lipid coating spans at least a portion of said metal sulfide-containing material, wherein the composition is prepared by a method comprising either the steps of:
contacting said metal sulfide-containing material with an effective amount of a first liquid dispersion comprising a lipid composition comprising a two-tail lipid, wherein said two-tail lipid comprises a hydrophilic head group attached to two hydrophobic tails, wherein at least one of said two hydrophobic tails contains one or more crosslinkable groups, thereby providing a non-crosslinked lipid-coated metal sulfide-containing material; and,
contacting said non-crosslinked lipid-coated metal sulfide-containing material with an effective amount of a second liquid dispersion comprising a chemical initiator for promoting lipid crosslinking, thereby providing a crosslinked lipid-coated metal sulfide-containing material;
or the steps of:
contacting an effective amount of a liquid dispersion comprising a lipid composition comprising a two-tail lipid, wherein said two-tail lipid comprises a hydrophilic head group attached to two hydrophobic tails, wherein at least one of said two hydrophobic tails contains one or more crosslinkable groups, with an effective amount of a liquid dispersion comprising a chemical initiator for promoting lipid crosslinking, thereby providing a third liquid dispersion comprising a crosslinked lipid; and,
contacting said third liquid dispersion with said metal sulfide-containing material, thereby providing a crosslinked lipid-coated metal sulfide-containing material.

35. The composition of claim 34, wherein said metal sulfide-containing material is selected from the group consisting of ore mine waste rock, coal repositories and metal sulfide tailings.

36. The composition of claim 34, wherein said metal sulfide-containing material comprises one or more metal sulfides selected from the group consisting of pyrite, marcasite, arsenopyrite, argentite, chalcopyrite, cinnabar, galena, molybdenite, pentlandite, realgar, sphalerite, stibnite, and combinations thereof.

37. The composition of claim 34, wherein said hydrophilic head group is selected from the group consisting of phosphate, phosphoryl, sulfate, amino, amine, carboxylate, hydroxyl, thiol, carbonyl, and combinations thereof.

38. The composition of claim 34, wherein said one or more crosslinkable groups are selected from the group consisting of alkenyl and alkynyl groups.

39. The composition of claim 38, wherein at least one of said one or more crosslinkable groups is diacetylenyl.

40. The composition of claim 34, wherein said chemical initiator is selected from the group consisting of hydrogen peroxide equivalents, azocompounds, and redox systems.

41. The composition of claim 40, wherein said hydrogen peroxide equivalents comprise a mixture of sodium bisulfite and sodium peroxodisulfate.

42. The composition of claim 34, wherein said two hydrophobic groups are attached to said hydrophilic head group by an ether or ester bond.

43. The composition of claim 34, wherein at least one of said two hydrophobic groups comprises a fatty acid moiety.

44. The composition of claim 43, wherein said fatty acid moiety is selected from the group consisting of 10,12-tricosadiynoyl, myristoleoyl, myristelaidoyl, palmitoleoyl, palmitelaidoyl, petroselinoyl, oleoyl, elaidoyl, linoleoyl, linolenoyl, eicosenoyl, arachidonoyl, erucoyl, 4,7,10,13,16,19-(all-cis)-docosahexaenoic, and nervonoyl.

45. The composition of claim 44, wherein said fatty acid moiety is 10,12-tricosadiynoyl.

46. The method of claim 34, wherein said two-tail lipid is 1,2-bis(10,12-tricosadiynoyl)-sn-glycero-3-phosphocholine.

47. The composition of claim 34, wherein said lipid composition further comprises a lipid selected from the group consisting of phosphatidylcholine, phosphatidylethanolamine, phosphatidic acid, phosphatidylinositol, sphingomyelin, diacyl glycerol, phosphatidyl ethanolamine, diacylaminopropanediols, disteroylaminopropanediol, phosphatidylglycerol, distearyl phosphatidylcholine, egg sphingomyelin, 1,2-dipalmitoyl-sn-glycero-3-[phospho-L-serine], 1,2-dimyristoyl-sn-glycero-3-[phospho-rac-(1-glycerol)], 1,2-bis(10,12-tricosadiynoyl)-sn-glycero-3-phosphocholine, 1,2-di-O-octadecyl-sn-glycero-3-phosphocholine and combinations thereof.

48. The composition of claim 34, wherein said lipid composition ranges in concentration from about 10 micromolar to about 30 millimolar in said first liquid dispersion.

49. The composition of claim 34, wherein said chemical initiator ranges in concentration from about 3 micromolar to about 30 millimolar in said second liquid dispersion.
